(19) United States
(12) Patent Application Publication
(10) Pub. No.: US 2015/0170287 A1
(43) Pub. Date: Jun. 18, 2015

(54) INSURANCE APPLICATIONS FOR AUTONOMOUS VEHICLES

(71) Applicant: The Travelers Indemnity Company, Hartford, CT (US)

(72) Inventors: Beth S. Tirone, Hebron, CT (US); Donna L. Glenn, Unionville, CT (US); Eileen P. Casey, Middlefield, CT (US); Dean M. Collins, Manchester, CT (US)

(73) Assignee: The Travelers Indemnity Company, Hartford, CT (US)

(21) Appl. No.: 14/132,426

(22) Filed: Dec. 18, 2013

(51) Int. Cl. G06Q 40/08

(52) U.S. Cl. CPC G06Q 40/08

(57) ABSTRACT

Systems, apparatus, interfaces, methods, and articles of manufacture that provide for insurance claims handling, underwriting, and risk assessment applications utilizing autonomous vehicle data.

### BACKGROUND

Insurance policies for automobiles and other vehicles are typically priced and issued based on risk assessments that rely on variables descriptive of characteristics of both the vehicle to be insured and the operator of the vehicle. Certain vehicle makes, models, and/or colors may be known to be associated with a higher number of occurrences of thefts, accidents, and/or damage, for example. Similarly, certain age groups of drivers, driver gender, and/or other driver characteristics may be known to be less likely to be involved in accidents or loss events.

The precise mix, weighting, and/or usage of variables are highly determinative of insurance company profitability and are accordingly generally closely guarded by competitors in the industry as proprietary knowledge. As vehicles transition from driver-controlled devices to, ultimately, driverless vehicles, however, the entire paradigm of vehicle insurance determinations is likely to dramatically change.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a chart according to some embodiments;

FIG. 2 is a block diagram of a chart of variables according to some embodiments;

FIG. 3 is a block diagram of a chart according to some embodiments;

FIG. 4 is a block diagram of a chart according to some embodiments;

FIG. 5 is a block diagram of a chart according to some embodiments;

FIG. 6 is a block diagram of a chart according to some embodiments;

FIG. 7 is a block diagram of a chart according to some embodiments;

FIG. 8 is a diagram of an example data storage structure according to some embodiments;

FIG. 9 is a flow diagram of a method according to some embodiments;

FIG. 10 is a block diagram of a system according to some embodiments;

FIG. 11 is a flow diagram of a method according to some embodiments;

FIG. 12 is a flow diagram of a method according to some embodiments;

FIG. 13 is a flow diagram of a method according to some embodiments;

FIG. 14 is a diagram of an exemplary risk matrix according to some embodiments;

FIG. 15 is a block diagram of an apparatus according to some embodiments; and

FIG. 16A, FIG. 16B, FIG. 16C, FIG. 16D, and FIG. 16E are perspective diagrams of exemplary data storage devices according to some embodiments.

### DETAILED DESCRIPTION

Embodiments described herein are descriptive of systems, apparatus, methods, interfaces, and articles of manufacture for insurance, underwriting, and/or risk assessment applications utilizing autonomous vehicle data. In some embodiments, for example, autonomous vehicle data may be utilized to (i) determine a risk assessment for a vehicle, fleet of vehicles, individual, household, and/or policy, (ii) determine an underwriting parameter, (iii) quote an insurance policy, (iv) sell an insurance policy, and/or (v) determine a type, blend, and/or mix of insurance types.

In some embodiments, risk assessment and/or insurance underwriting, pricing, quotation, sales, and/or claims processes may be conducted substantially similarly to approaches currently known in the art, and autonomous vehicle data may then be utilized to weight, adjust, scale, and/or otherwise modify the resulting risk assessment, underwriting, sales, and/or other insurance product-related determination. Such a procedure may be advantageous, for example, as customers of insurance and/or other underwriting products begin to purchase and/or employ autonomous vehicles. In other words, while autonomous vehicle use remains scattered and/or sparse, insurance practices may be modified to take into account autonomous vehicle parameters on a case-by-case basis, such as by applying modifiers to otherwise standard determinations.

According to some embodiments, autonomous vehicle data may be more integrally utilized in risk assessment, insurance underwriting, pricing, quotation, sales, and/or claims processes. One or more autonomous vehicle parameters may be utilized in addition to or in place of one or more standard parameters, for example, causing a determination to be made based on a mix of such autonomous vehicle parameters and non-autonomous vehicle parameters. Such a method may be advantageous, for example, as autonomous vehicles become more widespread, warranting modification not only of underwriting product decisions, but modification of the underlying processes as well.

As utilized herein, the term “autonomous vehicle data” may generally refer to any type, quantity, and/or configuration of data descriptive of one or more automatic, autonomous, and/or driverless features, aspects, and/or characteristics of a vehicle, vehicle system, and/or vehicle operator. In some embodiments, the autonomous vehicle data may be received, acquired, compiled, aggregated, and/or stored based on indications received from one or more telematic and/or wireless devices (e.g., a diagnostic device) associated with a vehicle. Autonomous vehicle data may be defined by and/or include data of various types relating to vehicle capabilities.

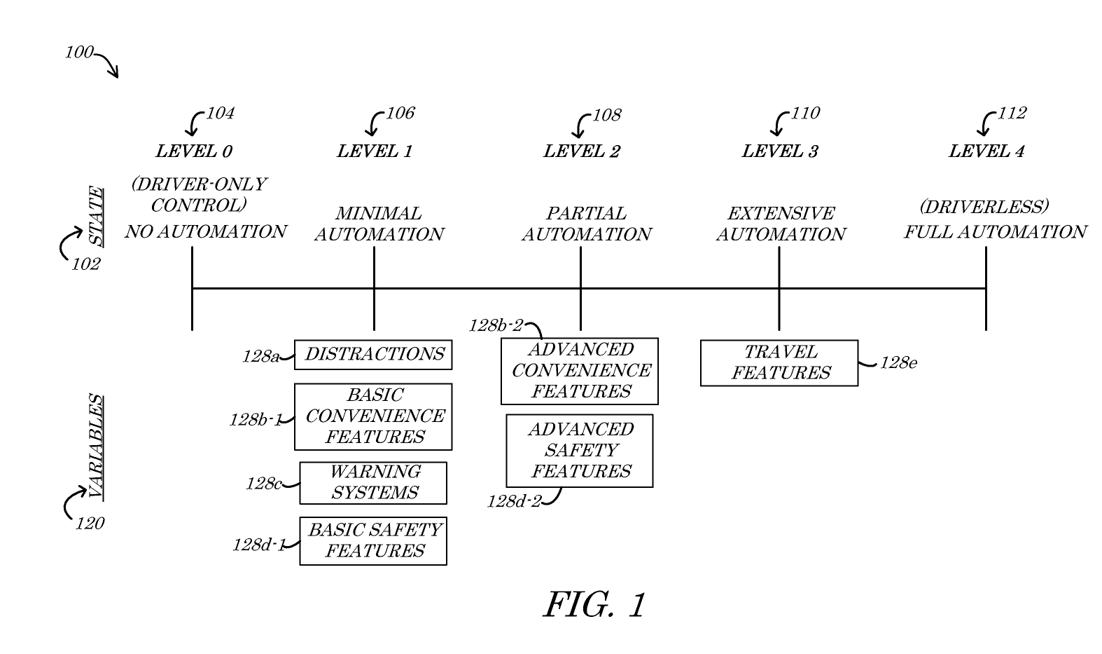

Referring first to FIG. 1 for example, a block diagram of a chart 100 according to some embodiments is shown. The chart 100 may, for example, depict a spectrum of vehicle capabilities ranging from those capabilities and/or features of a typical driver-operated and/or controlled vehicle to the capabilities and/or features of a “driverless” vehicle. As depicted, for example, vehicles may generally be characterized by various states 102 descriptive of a level of automation of the vehicle ranging from a state of no automation (e.g., driver-only control/no control systems being automated) 104, to a state of minimal automation 106, to a state of partial automation 108, to a state of extensive automation 110, to a state of full automation (e.g., “driverless”/the driver may set travel parameters but otherwise does not interact with vehicle control systems during driving) 112. In some embodiments, the depicted states 102 may correspond to the five (5) levels of automation (Level 0 to Level 4) proposed and published by the U.S. Department of Transportation's National Highway Traffic Safety Administration (NHTSA) on May 30, 2013.

In some embodiments, some or all of the various states 102 may be associated with one or more features, capabilities, parameters, and/or variables 120 related to automation of the vehicle. The state of minimal automation 106, for example, may be associated with various vehicle features such as distractions 128a, basic convenience features 128b-1, warning systems 128c, and/or basic safety features 128d-1. Distractions 128a may include, for example, automatic vehicle features provided for entertainment purposes such as telephone, stereo, radio, and/or video (e.g., Digital Video Disc (DVD) and/or solid-state stored media) features. In some embodiments, the “distractions” label may be utilized to indicate a feature or variable that is generally considered to negatively impact driver and/or vehicle safety (e.g., an in-vehicle display that provides contacts, e-mail, text message, and/or other media indications may generally detract from driver attentiveness and/or may be otherwise associated with an increased level of loss or damage with respect to other vehicle features). Basic convenience features 128b-1 may include, in some embodiments, automatic seat, steering wheel, control pedal, and/or mirror positioning and/or adjustment systems, automatic climate control features, automatic cruise control (e.g., automatic speed maintaining), etc.

Warning systems 128c may generally include features such as radar, sound, and/or optical sensors and/or related proximity and/or positioning monitoring devices such as lane departure warning systems, driver sleep sensors, backup sensors (and/or front or side proximity sensors), cameras, Tire Pressure Monitoring System (TPMS) sensors, temperature and/or road condition sensors, etc. According to some embodiments, basic safety features 128d-1 may include automatic air bags, automatic tensioning devices for passenger restraints, Anti-lock Braking System (ABS) devices, and/or traction control devices and/or systems (e.g., Electronic Stability Control (ESC) devices/automatic and/or pulse-braking systems).

In some embodiments, the state of partial automation 108 may be associated with one or more advanced convenience features 128b-2 and/or one or more advanced safety features 128d-2. The advanced convenience features 128b-2 may include, for example, automated parallel (and/or other) parking features, automatic and/or rain-sensing windshield wipers, etc. In some embodiments, the advanced safety features 128d-2 may include automatic braking (e.g., collision avoidance), automatic lane departure prevention (e.g., steering assist or auto-steering), automatic object avoidance (e.g., collision avoidance via auto-steering), and/or combinations thereof (e.g., Active Cruise Control (ACC)), etc.

According to some embodiments, the state of extensive automation 110 may be associated with one or more travel features 128e. The travel features 128e may, for example, comprise one or more devices, features, and/or systems that permit a vehicle to travel without driver interaction or input. Similar to an auto-pilot feature of an aircraft, for example, a vehicle may include a system (e.g., hardware and/or stored instructions) that utilizes a variety of vehicle systems and/or features to set, change, and/or maintain travel speed, travel direction, travel in a particular lane, travel maintaining a certain distance from other objects, etc. A vehicle in a state of extensive automation 110 may generally require an operator/driver to be present but may otherwise allow the operator to control the vehicle with minimal input (e.g., input of a destination). Such a vehicle may generally be referred to as “autonomous” or “fully automatic”, such terms being descriptive of the characteristic(s) of the vehicle that permit the vehicle to function with minimal operator input. In some embodiments, a vehicle in a state of full automation 112 may be similar to the vehicle in the state of extensive automation 110, but may be configured and/or enabled to operate without any operator/driver interaction. At this extreme end of the spectrum depicted in FIG. 1, for example, a vehicle may be considered “driverless”. Indeed, such a vehicle may be capable of traveling between locations without any human driver/operator being on-board (e.g., “automatic valet” functionality where a vehicle may park and/or retrieve itself). Such a vehicle may, for example, be programmed and/or configured to automatically travel to a grocery store and automatically return to a user's home with groceries (e.g., loaded by an employee and/or device at the grocery store, warehouse, etc.), without any humans being present in the vehicle.

According to some embodiments, any or all of the components 102, 104, 106, 108, 110, 112, 120, 128a, 128b-1, 128b-2, 128c, 128d-1, 128d-2, 128e of the chart 100 may be similar in configuration and/or functionality to any similarly named and/or numbered components described herein. Fewer or more components 102, 104, 106, 108, 110, 112, 120, 128a, 128b-1, 128b-2, 128c, 128d-1, 128d-2, 128e and/or various configurations of the components 102, 104, 106, 108, 110, 112, 120, 128a, 128b-1, 128b-2, 128c, 128d-1, 128d-2, 128e may be included in the chart 100 without deviating from the scope of embodiments described herein.

Most vehicles today are generally configured in a state of minimal automation 106 while some vehicles available in the marketplace are in a state of partial automation 108. Owners and/or operators of such vehicles generally desire or are required to purchase automobile insurance policies for on-road vehicles configured in such states 106, 108. For the most part, insurance companies analyze the risk of such policies, underwrite such policies, and/or quote or sell such policies based on an analysis of traditional variables such as driver age, driver gender, type of vehicle, or even a ZIP code associated with the driver/vehicle. As vehicle technology continues to progress along the spectrum toward the state of full automation 112, however, such standard insurance practices may become undesirable or obsolete.

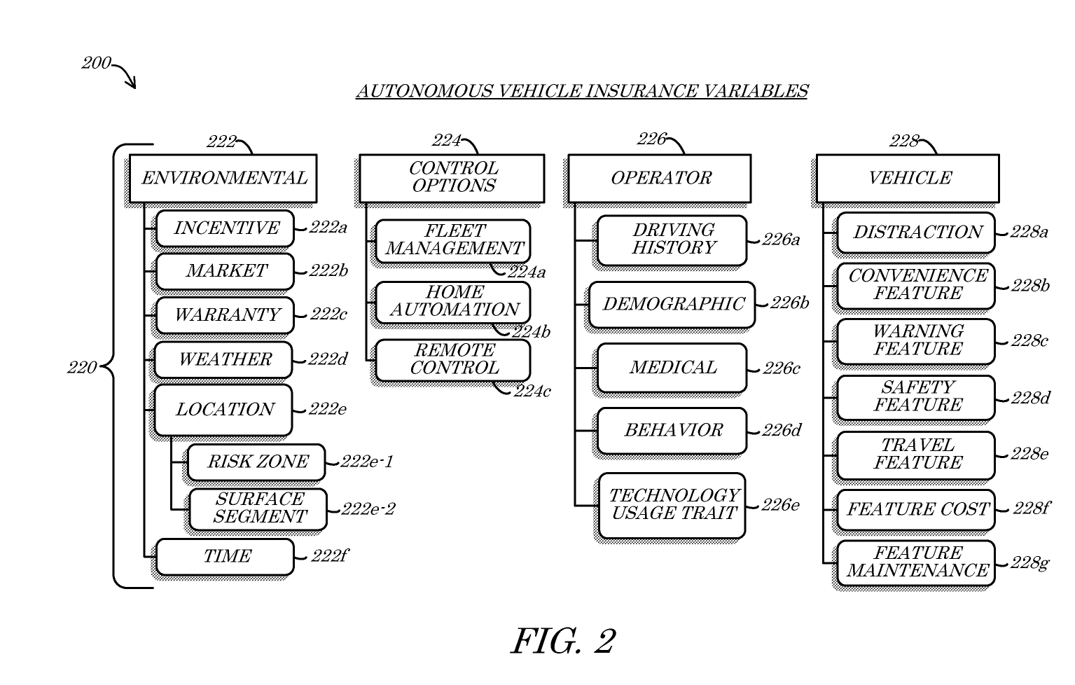

Turning to FIG. 2 for example, a block diagram of a chart 200 of variables 220 according to some embodiments is shown. The variables 220 may, for example, comprise environmental variables 222, control option variables 224, operator variables 226, and/or vehicle variables 228.

In some embodiments, the variables 220 may comprise and/or be descriptive of various categories, classifications, and/or groups of parameters, metrics, and/or values utilized in relation to insurance and/or underwriting products. The variables 220 may, for example, be utilized to select, evaluate risk for, underwrite, quote, sell, renew, adjust, re-sell, and/or otherwise conduct one or more processes in association with and/or based on an insurance and/or underwriting product. Some of the variables 220 may be utilized in current insurance-related processes, while many of the variables 220 may represent variables that have not previously been utilized with respect to vehicle insurance offerings (e.g., a subset of the variables 220 unique to and/or descriptive of autonomous and/or driverless vehicle features and/or parameters).

According to some embodiments, the environmental variables 222 may comprise and/or be divided and/or grouped into one or more of incentive variables 222a, market variables 222b, warranty variables 222c, weather variables 222d, location variables 222e (e.g., risk zone variables 222e-1 and/or surface segment variables 222e-2), and/or time variables 222f. Incentive variables 222a may, in some embodiments, be descriptive of various financial and/or municipal incentives offered with respect to autonomous vehicles such as tax incentives, special parking incentives, etc. Market variables 222b may, in some embodiments, be descriptive of various characteristics of the vehicle marketplace, such as the overall and/or average number (or percentage) of autonomous vehicles in the market, on a particular roadway, and/or in an area associated with an insured. Warranty variables 222c may, in some embodiments, be descriptive of product warranty parameters and/or incentives or coverage characteristics relevant to an autonomous vehicle and/or one or more components thereof. Weather variables 222d may, in some embodiments, be descriptive of one or more past, current, and/or future (e.g., predicted/modeled) weather conditions associated with an autonomous vehicle and/or autonomous vehicle system or component (e.g., in the case that a particular weather type causes problems with a particular autonomous vehicle feature and such weather type occurs frequently where a particular autonomous vehicle is operated).

Location variables 222e may, in some embodiments, be descriptive of one or more locations associated with use and/or operation of an autonomous vehicle. According to some embodiments, the location variables 222e may comprise risk zone variables 222e-1 and/or surface segment variables 222e-2. Risk zone variables 222e-1 may be descriptive of one or more areas and/or roadways associated with particular levels of risk, for example, as described in U.S. patent application Ser. No. 13/334,897 titled “SYSTEMS AND METHODS FOR CUSTOMER-RELATED RISK ZONES” and filed on Dec. 22, 2011, the risk zone concepts and descriptions of which are hereby incorporated by reference herein. Surface segment variables 222e-2 may be descriptive of one or more roadway characteristics associated with use and/or operation of an autonomous vehicle, for example, as described in U.S. patent application Ser. No. 13/723,685 titled “SYSTEMS AND METHODS FOR SURFACE SEGMENT DATA” and filed on Dec. 21, 2012, the surface segment concepts and descriptions of which are hereby incorporated by reference herein. Time variables 222f may, in some embodiments, be descriptive of one or more dates, times, days of the week, times of day, and/or seasonal variables associated with use and/or operation of an autonomous vehicle.

In some embodiments, the control option variables 224 may comprise and/or be divided and/or grouped into one or more of fleet management variables 224a, home automation variables 224b, and/or remote control variables 224c. Fleet management variables 224a may, in some embodiments, be descriptive of one or more fleet management characteristics, such as fleet tracking, telematics, and/or monitoring capabilities and/or systems. Home automation variables 224b may, in some embodiments, be descriptive of functionality that ties autonomous vehicle operation to a home control and/or security system. Remote control variables 224c may, in some embodiments, be descriptive of autonomous vehicle remote control and/or remote operation capabilities (such as setting and/or triggering a driverless vehicle trip from a location remote from the vehicle).

According to some embodiments, the operator variables 226 may comprise and/or be divided and/or grouped into one or more of driving history variables 226a, demographic variables 226b, medical variables 226c, behavior variables 226d, and/or technology usage trait variables 226e. Driving history variables 226a may, in some embodiments, be descriptive of two classes of variables descriptive of a vehicle operator's driving history. A first class of driving history variables 226a may, for example, comprise traditional variables (i.e., “traditional driving history variables”) utilized in insurance processing, such as whether the operator has been involved in and/or caused previous accidents or loss events. A second class of driving history variables 226a may, for example, comprise variables specific to autonomous vehicles (i.e., “autonomous vehicle driving history variables”), such as operator experience utilizing autonomous vehicles (e.g., time-in-type, classes taken, training), operator proficiency with autonomous vehicles (e.g., training and/or evaluation scores or results), etc.

Demographic variables 226b may, in some embodiments, be descriptive of two classes of variables descriptive of a vehicle operator's demographic characteristics. A first class of demographic variables 226b may, for example, comprise traditional variables (i.e., “traditional demographic variables”) utilized in insurance processing, such as the operator's age or gender. A second class of demographic variables 226b may, for example, comprise variables specific to autonomous vehicles (i.e., “autonomous vehicle demographic variables”), such as operator education level, operator occupation, etc. Medical variables 226c may, in some embodiments, be descriptive of operator medical characteristics, such as height, weight, blood pressure, eye sight evaluation metrics, hearing evaluation metrics, etc.

Behavior variables 226d may, in some embodiments, be descriptive of one or more past, current, and/or future (e.g., predicted or expected) behaviors of an operator, such as a propensity of the operator to forget to turn autonomous vehicle features on or off, a propensity of the operator to speed (e.g., when in control of a vehicle), etc. Technology usage trait variables 226e may, in some embodiments, be descriptive of traits and/or characteristics of the operator that relate to how the operator interacts with (uses and/or misuses) technology, e.g., a level of proficiency of the operator with Personal Computer (PC) devices, cellular telephones, video games, etc.

In some embodiments, the vehicle variables 228 may comprise and/or be divided and/or grouped into one or more of distraction variables 228a, travel feature variables 228b, warning feature variables 228c, safety feature variables 228d, convenience feature variables 228e, feature cost variables 228f, and/or feature maintenance variables 228g. Distraction variables 228a may, in some embodiments, be descriptive of a number, type, and/or quantity of features of an autonomous vehicle that may be considered distracting (e.g., detrimental) to an operator and/or an operator's control of the vehicle. Travel feature variables 228b may, in some embodiments, be descriptive of a number, type, and/or quantity of features of an autonomous vehicle that may be considered to enable the vehicle to undertake some level of autonomous travel. Warning feature variables 228c and safety feature variables 228d may, in some embodiments, be descriptive of a number, type, and/or quantity of features of an autonomous vehicle that are configured to provide warnings and/or other safety-enhancing capabilities to an operator and/or to the vehicle. Convenience feature variables 228e may, in some embodiments, be descriptive of a number, type, and/or quantity of features of an autonomous vehicle that may be considered to offer convenience to an operator. According to some embodiments, such convenience features may be also or alternatively considered distractions or safety features, depending upon their effect on vehicle operation. Feature cost variables 228f may, in some embodiments, be descriptive of a replacement and/or repair cost associated with one or more autonomous vehicle features. Feature maintenance variables 228g may, in some embodiments, be descriptive of maintenance characteristics of one or more autonomous vehicle features such as maintenance frequency, cost, and/or consequence (e.g., does the feature cease to function if not properly maintained or simply lose efficiency) characteristics.

According to some embodiments, any or all of the components 220, 222a-f, 224a-c, 226a-e, 228a-g of the chart 200 may be similar in configuration and/or functionality to any similarly named and/or numbered components described herein. Fewer or more components 220, 222a-f, 224a-c, 226a-e, 228a-g and/or various configurations of the components 220, 222a-f, 224a-c, 226a-e, 228a-g may be included in the chart 200 without deviating from the scope of embodiments described herein.

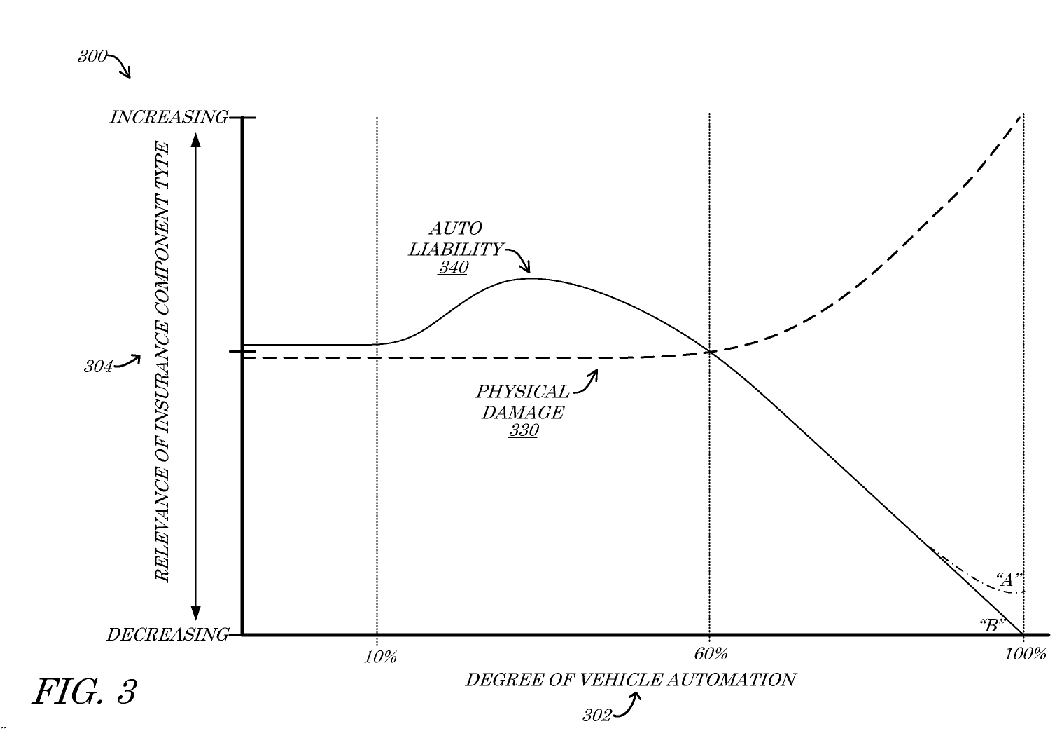

Referring now to FIG. 3, a block diagram of a chart 300 according to some embodiments is shown. The chart 300 may, for example, comprise an X-axis 302 descriptive of a degree of vehicle automation (the degree of automation increasing from left to right) and/or a Y-axis 304 descriptive of a relevance of insurance component type (increasing in relevance from bottom to top). As depicted with respect to an automobile (and/or other vehicle) insurance policy, an expected change in relevance of an auto physical damage component 330 and/or an expected change in relevance of an auto liability component 340 may be plotted.

According to some embodiments, any or all of the components 302, 304, 330, 340 of the chart 300 may be similar in configuration and/or functionality to any similarly named and/or numbered components described herein. Fewer or more components 302, 304, 330, 340 and/or various configurations of the components 302, 304, 330, 340 may be included in the chart 300 without deviating from the scope of embodiments described herein.

In some embodiments, it may be expected that the auto physical damage component 330 and the auto liability component 340 may be of generally the same relevance to the risk assessment, underwriting, pricing, quotation, selling, and/or renewal or adjustment of insurance policy parameters. In such a relationship, typical insurance underwriting and/or processing may be utilized without requiring or warranting any changes due to vehicle automation levels (e.g., typical insurance variables such as driver age and/or gender may be utilized to affect policy processing—e.g., first classes of the driving history variables 226a and/or demographic variables 226b of FIG. 2). This relationship may hold true for a certain amount of vehicle automation (e.g., approximately ten percent (10%) automation as depicted in the example of FIG. 3) but may change dramatically and/or significantly as vehicle automation increases.

According to some embodiments, it may be expected that increased vehicle automation levels may actually increase the relevance of the auto liability component 340. As depicted between approximately ten percent (10%) and sixty percent (60%) vehicle automation levels, for example, the auto liability component 340 may increase in relevance to insurance processing, e.g., due to operator errors and/or learning issues associated with the introduction of new autonomous vehicle technologies and/or features. In such a situation, autonomous vehicle variables may be utilized to alter insurance processing in a generally negative manner—e.g., an autonomous vehicle feature and/or variable may negatively affect policy pricing and/or issuance.

In some embodiments, after the initial increase in the relevance of the auto liability component 340 (and/or in the absence of such an increase), the relevance of the auto liability component 340 may significantly decrease and/or the relevance of the auto physical damage component 330 may significantly increase. As vehicles become significantly autonomous (e.g., approximately sixty percent (60%) or more), for example, driver actions (e.g., liability) may have significantly less impact on damage and/or losses, while the increased cost of autonomous technology features may raise the repair cost of such vehicles.

According to some embodiments, as a vehicle (or fleet or group of vehicles) approaches and/or achieves full autonomy (e.g., a “driverless vehicle” state such as the state of full automation 112 of FIG. 1), two possibilities may emerge, depending on how such vehicles are treated under applicable laws and regulations. Under a first scenario labeled “A” in FIG. 3, an owner and/or operator of a driverless vehicle may remain responsible for some level of liability due to actions and/or operations of the vehicle such that the relevance of the auto liability component 340 is significantly reduced, but still present and relevant to auto insurance processing. Under a second scenario labeled “B” in FIG. 3, any liability for a fully autonomous vehicle may rest with the manufacturer (e.g., product liability), thus reducing the relevance of the auto liability component 340 to zero (or near zero). In the second scenario, automobile insurance policies may be transformed into property and/or product damage policies in which the auto liability component 340 is not relevant.

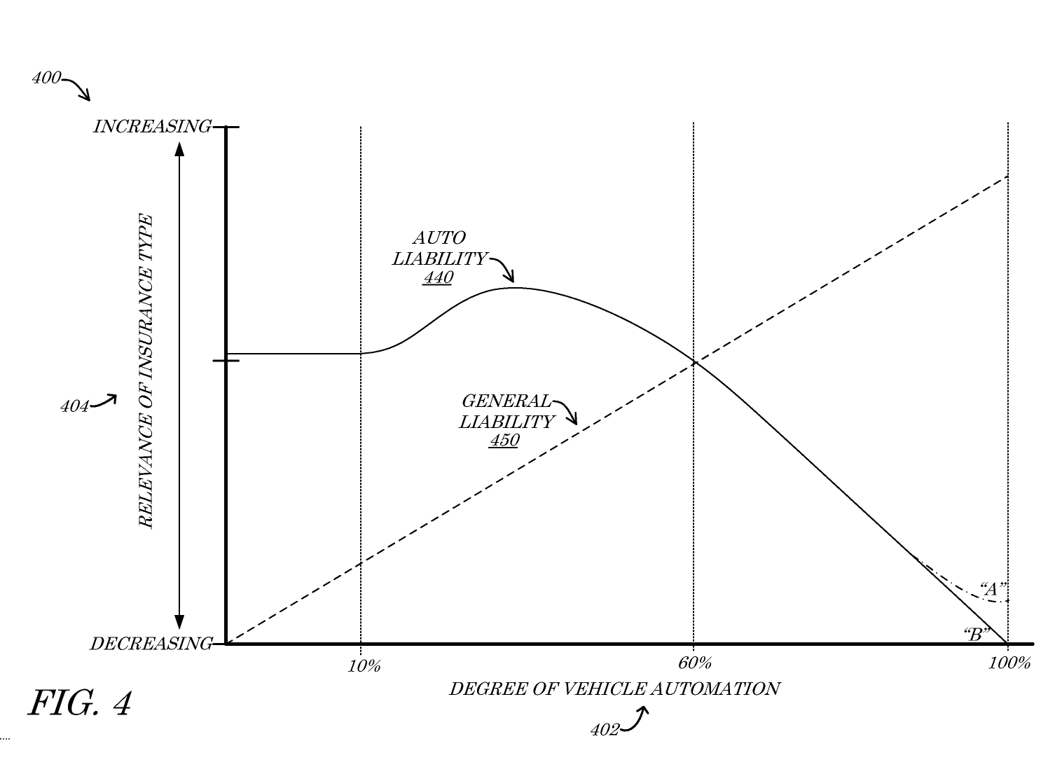

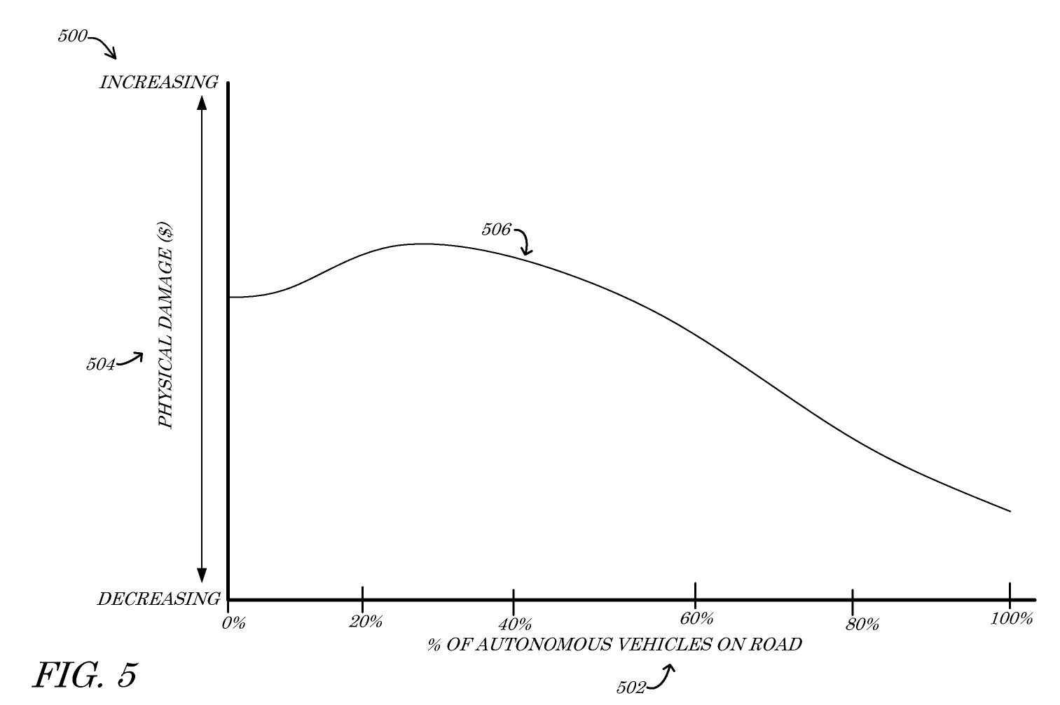

Turning to FIG. 4 for example, a block diagram of a chart 400 according to some embodiments is shown. The chart 400 may, for example, comprise an X-axis 402 descriptive of a degree of vehicle automation (the degree of automation increasing from left to right) and/or a Y-axis 404 descriptive of a relevance of insurance type (increasing in relevance from bottom to top). As depicted with respect to an automobile (and/or other vehicle) insurance policy, an expected change in relevance of an auto liability insurance type 440 and/or an expected change in relevance of general liability insurance type 450 may be plotted.

According to some embodiments, any or all of the components 402, 404, 440, 450 of the chart 400 may be similar in configuration and/or functionality to any similarly named and/or numbered components described herein. Fewer or more components 402, 404, 440, 450 and/or various configurations of the components 402, 404, 440, 450 may be included in the chart 400 without deviating from the scope of embodiments described herein.

In some embodiments, the expected relevance of the auto liability insurance type 440 may initially increase somewhat and then significantly decrease, as vehicle automation increases. Under a first scenario labeled “A” in FIG. 4, an owner and/or operator of a driverless vehicle may remain responsible for some level of liability due to actions and/or operations of the vehicle such that the relevance of the auto liability insurance type 440 is significantly reduced, but still present and relevant to insurance processing. Under a second scenario labeled “B” in FIG. 4, any liability for a fully autonomous vehicle may rest with the manufacturer (e.g., product liability), thus reducing the relevance of the auto liability insurance type 440 to zero (or near zero). In either scenario (but particularly in the second scenario), automobile insurance policies may be transformed such that they provide coverage for property and/or product damage, but liability may be shifted to the general liability insurance type 450.

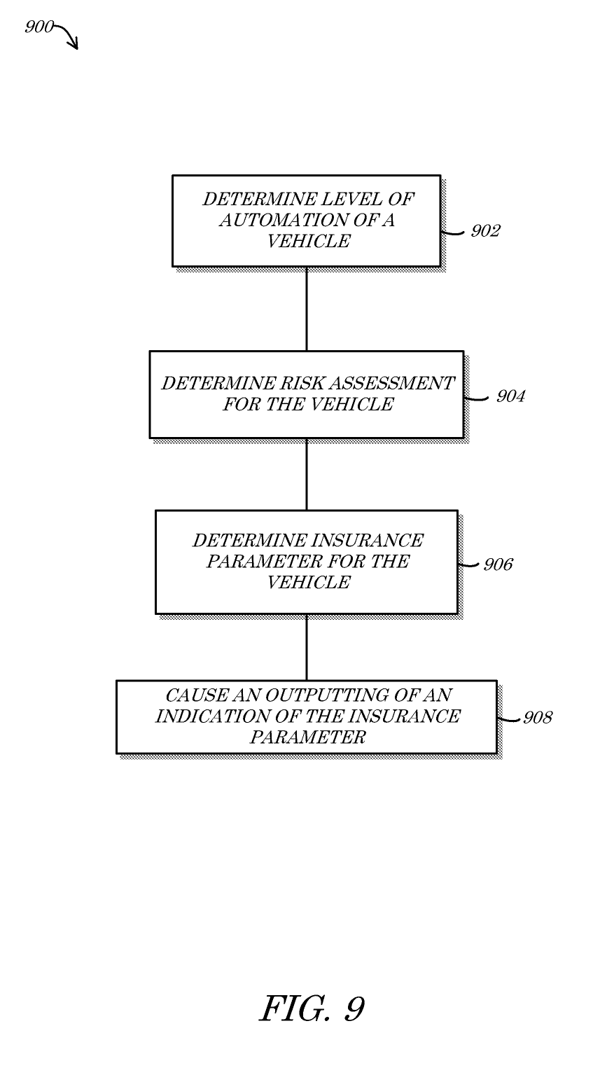

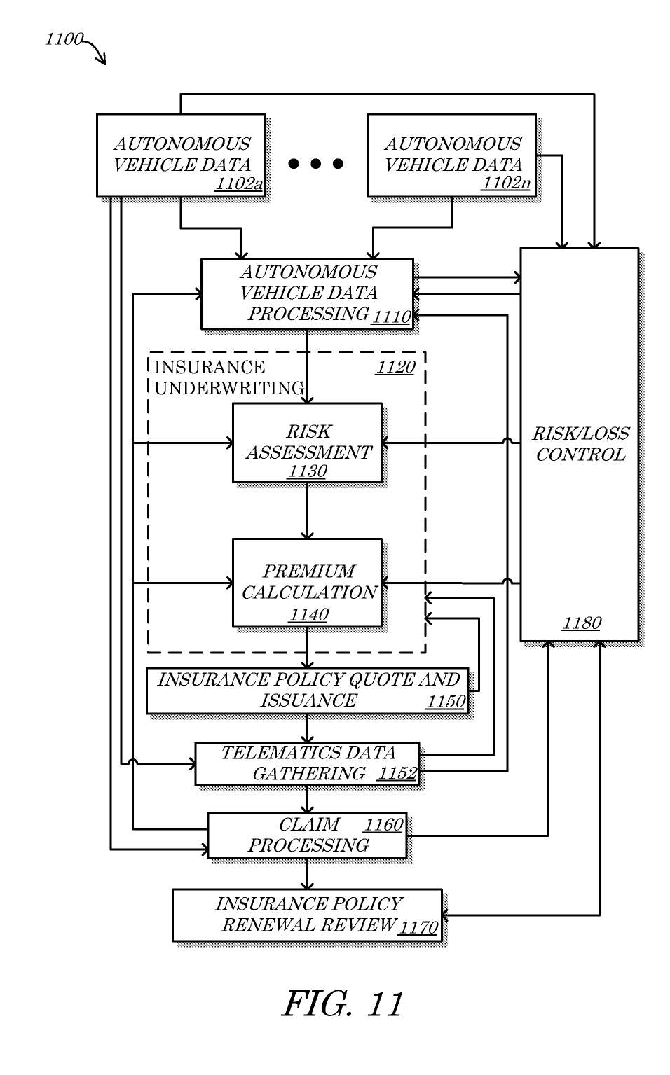

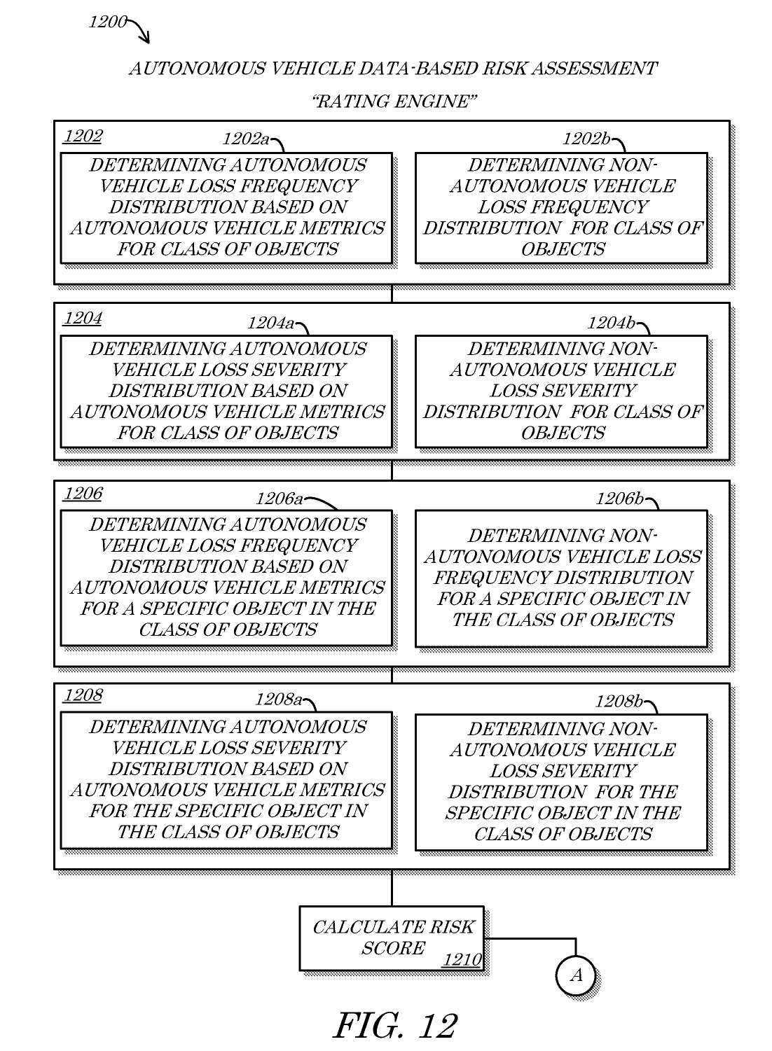

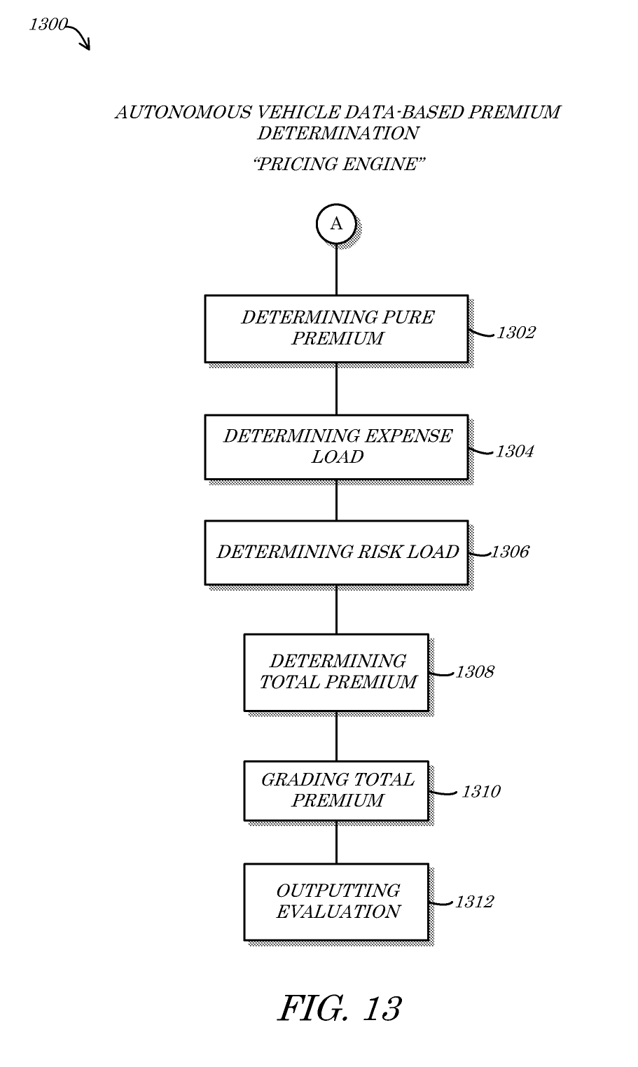

As depicted in FIG. 4, for example, as vehicle automation levels increase, the relevance of the general liability insurance type 450 may increase. As full automation is approached, the traditional auto liability insurance type 440 may be greatly reduced and/or eclipsed in relevance by the general liability insurance type 450. Such a shift in insurance types 440, 450 related to vehicle and/or operator insurance coverage may be expected to necessitate changes in the manner in which insurance policies covering such objects/activities are processed (e.g., in accordance with the methods 900, 1100, 1200, 1300 of FIG. 9, FIG. 11, FIG. 12, and/or FIG. 13 herein).

Referring now to FIG. 5, a block diagram of a chart 500 according to some embodiments is shown. The chart 500 may, for example, comprise an X-axis 502 descriptive of a measure of a utilization of autonomous vehicle features (e.g., percent of autonomous vehicles “on the road” (e.g., in the market and/or actually expected on average and/or with respect to one or more particular locations/roads/areas), a percentage of vehicle features related to autonomous operation, and/or a measure of how often (absolutely or relatively) a vehicle/driver/group of vehicles are utilized with respect to autonomous operation; the percent of autonomous vehicles increasing from left to right) and/or a Y-axis 504 descriptive of an expected level of vehicle-related damage or losses (increasing in magnitude from bottom to top). As depicted, an expected change in physical damage magnitudes may be plotted with respect to changes in autonomous vehicle market penetration, indicating a physical damage trend 506. In some embodiments, the X-axis 502 may be based on a certain level of automation for vehicles on the road (e.g., what percentage of vehicles on the road/in the market meet a minimum threshold of automation) and/or may be based on an overall score and/or weighted degree of automation for all such vehicles (e.g., a “scoring factor”). In some embodiments, the percent of autonomous vehicles may be descriptive of a percent of driverless vehicles (e.g., fully autonomous vehicles). In some embodiments, the Y-axis 504 may be based on and/or descriptive of average, maximum, and/or other expected damage and/or loss levels (e.g., expressed in monetary terms as depicted) for vehicles in general, for autonomous vehicles, for non-autonomous vehicles, and/or for one or more particular vehicles or groups of vehicles.

According to some embodiments, any or all of the components 502, 504, 506 of the chart 500 may be similar in configuration and/or functionality to any similarly named and/or numbered components described herein. Fewer or more components 502, 504, 506 and/or various configurations of the components 502, 504, 506 may be included in the chart 500 without deviating from the scope of embodiments described herein.

In some embodiments, it may be expected that physical damage and/or losses may initially increase as more autonomous (and/or driverless) vehicles are introduced on the roadways. There may, for example, be a difficulty with respect to how autonomous and/or driverless vehicles interact with non-autonomous vehicles and/or drivers thereof. Indeed, drivers of traditional vehicles may find it difficult to properly interact with driverless vehicles operating on the same roadway, particularly on multi-lane roadways. In some embodiments, it may be assumed that once any initial compatibility issues are resolved (through direct action, passive learning, and/or simply due to a phase-out of non-autonomous vehicles), physical damage losses may be expected to decrease significantly. Once a large percentage of vehicles on any given roadway (and/or other area) are highly-autonomous and/or driverless, for example, they may be capable of much higher levels of safety and/or highly decreased likelihoods of accidents and/or loss events than were obtainable by human drivers operating non-autonomous vehicles. Such changes in physical damage probabilities may be expected to necessitate changes in the manner in which insurance policies covering such objects/activities are processed (e.g., in accordance with the methods 900, 1100, 1200, 1300 of FIG. 9, FIG. 11, FIG. 12, and/or FIG. 13 herein).

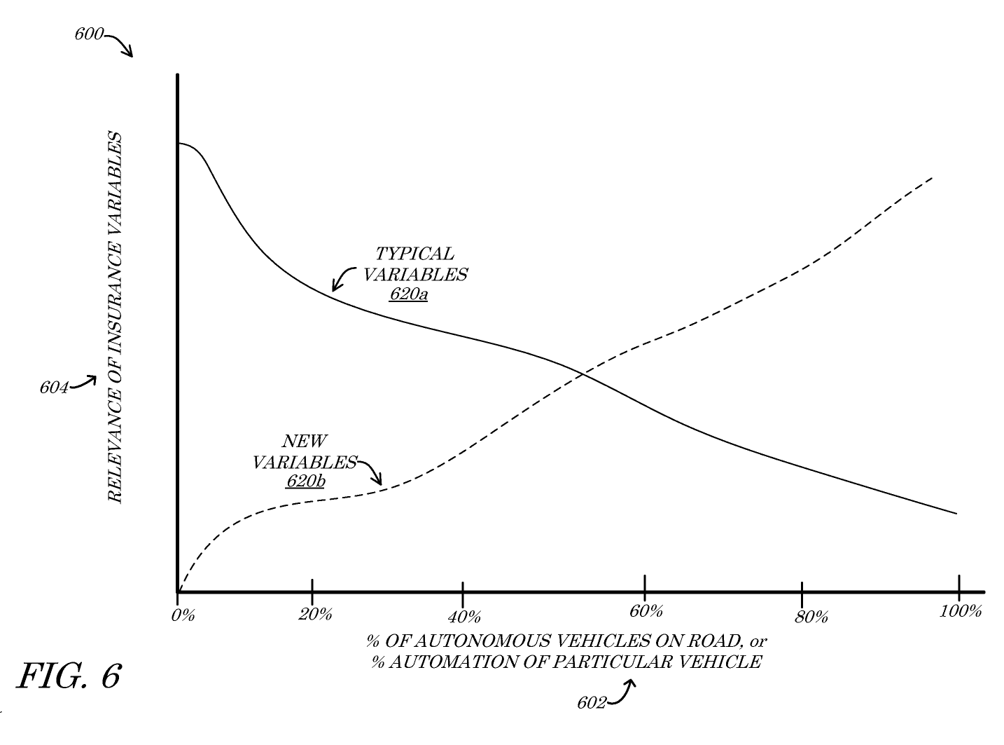

Turning to FIG. 6 for example, a block diagram of a chart 600 according to some embodiments is shown. The chart 600 may, for example, comprise an X-axis 602 descriptive of a measure of a utilization of autonomous vehicle features (e.g., percent of autonomous vehicles “on the road” (e.g., in the market and/or actually expected on average and/or with respect to one or more particular locations/roads/areas), a percentage of vehicle features related to autonomous operation, and/or a measure of how often (absolutely or relatively) a vehicle/driver/group of vehicles are utilized with respect to autonomous operation; the percent of autonomous vehicles increasing from left to right) and/or a percent of automation for a particular vehicle and/or group of vehicles, and/or a Y-axis 604 descriptive of a relevance of insurance variables (increasing in relevance from bottom to top). As depicted with respect to an automobile (and/or other vehicle) insurance policy, an expected change in relevance of typical variables 620a and/or an expected change in relevance of new variables 620b may be plotted.

According to some embodiments, any or all of the components 602, 604, 620a-b of the chart 600 may be similar in configuration and/or functionality to any similarly named and/or numbered components described herein. Fewer or more components 602, 604, 620a-b and/or various configurations of the components 602, 604, 620a-b may be included in the chart 600 without deviating from the scope of embodiments described herein.

In some embodiments (e.g., as depicted in FIG. 6), it may be expected that changes in physical damage and/or liability parameters and/or models due to autonomous vehicles may cause a shift in the types of variables 620a-b utilized to conduct insurance processes. The relevance of typical variables 620a (such as driver age, gender, and/or vehicle type) may steadily decrease as vehicle and/or marketplace automation increase, for example, while the relevance of new variables 620b may increase. As the percent of automation approaches a state of full automation (e.g., a vehicle is or becomes driverless and/or a roadway is or becomes predominantly utilized by driverless vehicles), the new variables 620b may dominate insurance processing. In some embodiments, the mix of variables 620a-b may be with respect to one or more relevant insurance types and/or components (e.g., auto liability, physical damage, personal excess, umbrella, and/or general liability). According to some embodiments, the change in the mix of variables 620a-b may or may not substantially alter the total number of variables utilized to conduct insurance processing.

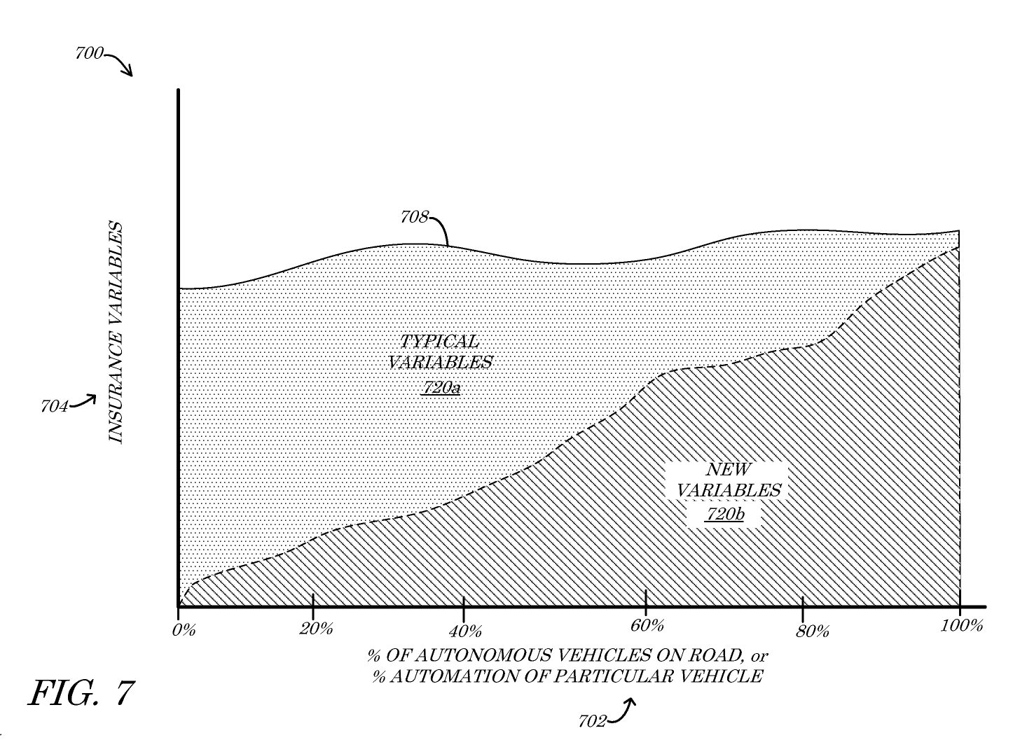

Referring to FIG. 7 for example, a block diagram of a chart 700 according to some embodiments is shown. The chart 700 may, for example, comprise an X-axis 702 descriptive of a measure of a utilization of autonomous vehicle features (e.g., percent of autonomous vehicles “on the road” (e.g., in the market and/or actually expected on average and/or with respect to one or more particular locations/roads/areas), a percentage of vehicle features related to autonomous operation, and/or a measure of how often (absolutely or relatively) a vehicle/driver/group of vehicles are utilized with respect to autonomous operation; the percent of autonomous vehicles increasing from left to right) and/or a percent of automation for a particular vehicle and/or group of vehicles, and/or a Y-axis 704 descriptive of a number of insurance variables (increasing in relevance from bottom to top). As depicted with respect to an automobile (and/or other vehicle) insurance policy, an expected change in the number of typical variables 720a and/or an expected change in the number of new variables 720b may be plotted, providing an indication of a total number of variables 708 (e.g., utilized for insurance processing).

According to some embodiments, any or all of the components 702, 704, 708, 720a-b of the chart 700 may be similar in configuration and/or functionality to any similarly named and/or numbered components described herein. Fewer or more components 702, 704, 708, 720a-b and/or various configurations of the components 702, 704, 708, 720a-b may be included in the chart 700 without deviating from the scope of embodiments described herein

In some embodiments, while the ratio of typical variables 720a to new variables 720b may be expected to change as vehicles become more autonomous (in general and/or specifically), the total number of variables 708 may generally remain at approximately the same level. Insurance underwriting may, for example, be logistically and/or practically limited to utilization and/or consideration of a certain range of total number of variables 708 (e.g., it may be time and/or cost-prohibitive to consider a large number of variables). In such cases, while the total number of variables 708 utilized to inform insurance processing decisions may remain approximately the same as vehicles become more autonomous, the particular variables utilized may change significantly (e.g., as depicted). According to some embodiments, how such variables are utilized may also or alternatively differ from traditional insurance processing practices (e.g., in accordance with the methods 900, 1100, 1200, 1300 of FIG. 9, FIG. 11, FIG. 12, and/or FIG. 13 herein).

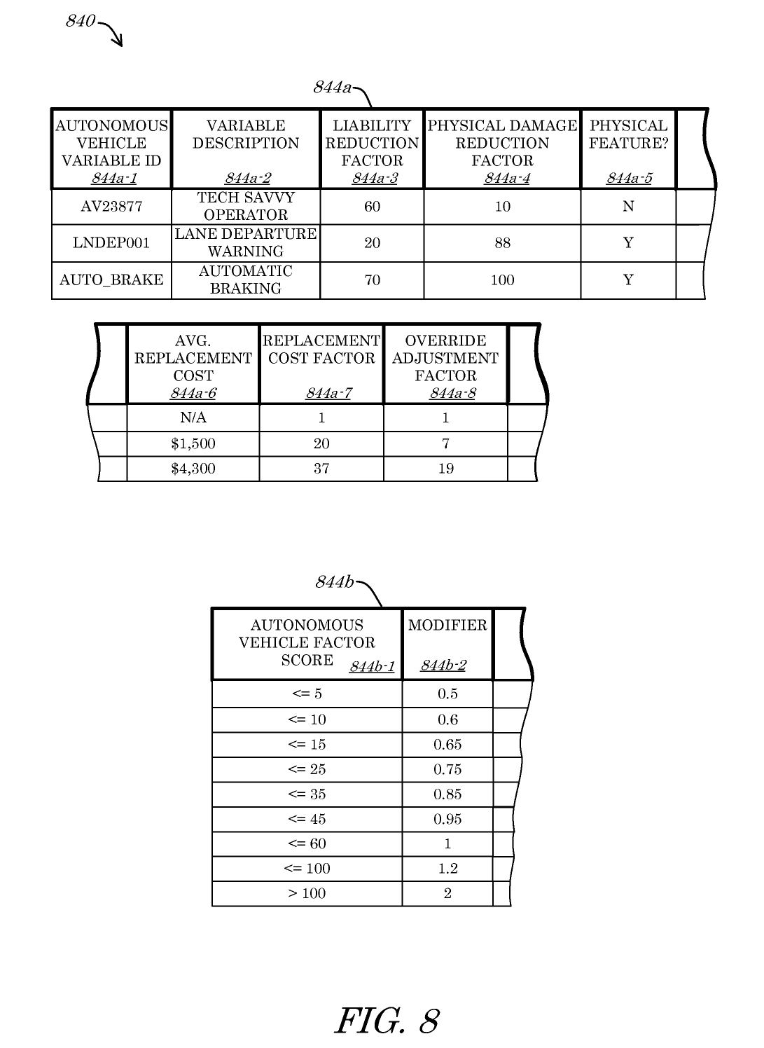

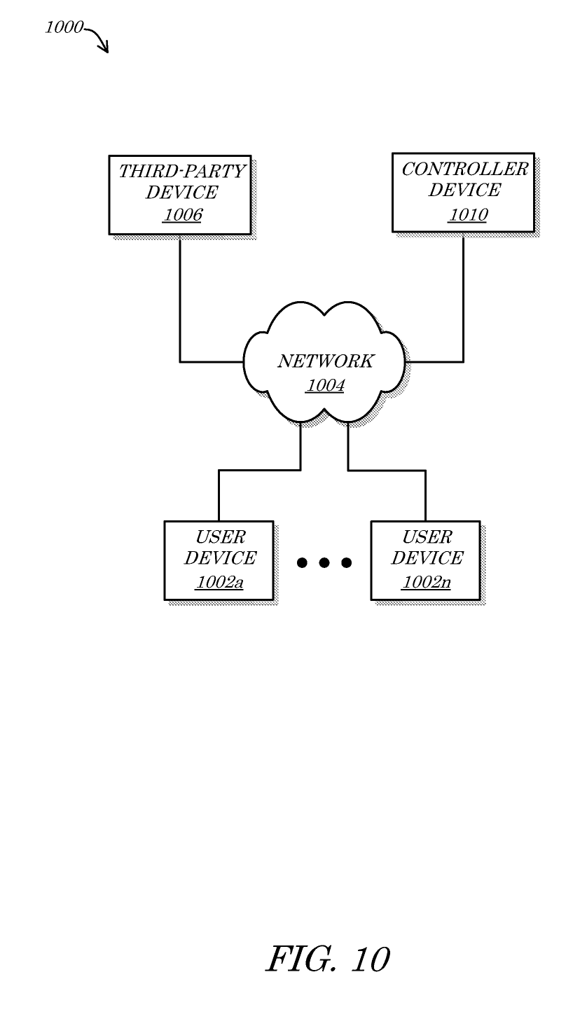

Referring now to FIG. 8, a diagram of an example data storage structure 840 according to some embodiments is shown. In some embodiments, the data storage structure 840 may comprise a plurality of data tables such as an autonomous vehicle data table 844a and/or an autonomous vehicle factor table 844b. The data tables 844a-b may, for example, be utilized (e.g., in accordance with the methods 900, 1100, 1200, 1300 of FIG. 9, FIG. 11, FIG. 12, and/or FIG. 13 herein) to store, determine, and/or utilize various autonomous vehicle data (e.g., provided by a user device 1002a-n of FIG. 10), such as to assess risk for (e.g., providing risk and/or loss control services), price, quote, adjust claims for, sell, renew, revise, and/or re-sell one or more risk management products (e.g., underwriting products). In some embodiments, the data tables 844a-b may be utilized to perform and/or provide various services such as pricing, underwriting, servicing, marketing, and/or making recommendations (e.g., risk, marketing, and/or other recommendations).

The autonomous vehicle data table 844a may comprise, in accordance with some embodiments, an autonomous vehicle variable IDentifier (ID) field 844a-1, a variable description field 844a-2, a liability reduction factor field 844a-3, a physical damage reduction factor field 844a-4, a physical feature flag field 844a-5, an average replacement cost field 844a-6, a replacement cost factor field 844a-7, and/or an override adjustment factor field 844a-8. Any or all of the number and/or ID fields 844a-1 described herein may generally store any type of identifier that is or becomes desirable or practicable (e.g., a unique identifier, an alphanumeric identifier, and/or an encoded identifier).

In some embodiments, the autonomous vehicle variable ID field 844a-1 may store data indicative of a particular autonomous vehicle variable, such as any of the variables 220 of FIG. 2. According to some embodiments, the variable description field 844a-2 may store data indicative of the type, category, group, and/or characteristics or name for a particular variable. In some embodiments, the liability reduction factor field 844a-3 may store data indicative of a metric, score, rank, parameter, and/or value descriptive of a likelihood of and/or magnitude to which the particular variable is expected to affect insurance liability associated with an autonomous vehicle (in a positive or negative manner). According to some embodiments, the physical damage reduction factor field 844a-4 may store data indicative of a metric, score, rank, parameter, and/or value descriptive of a likelihood of and/or magnitude to which the particular variable is expected to affect occurrences of physical damage to an autonomous vehicle (in a positive or negative manner).

In some embodiments, the physical feature flag field 844a-5 may store data indicative of whether the particular variable is descriptive of a technological feature of an autonomous vehicle (e.g., the vehicle variables 228 of FIG. 2). According to some embodiments, the average replacement cost field 844a-6 may store data indicative of (e.g., in the case that the variable is descriptive of a vehicle feature) a historical, actual, and/or predicted or expected replacement or repair cost of an autonomous vehicle feature (e.g., cost per accident or loss event). In some embodiments, the replacement cost factor field 844a-7 may store data indicative of a weighting factor associated with the average replacement cost field 844a-6. According to some embodiments, the override adjustment factor field 844a-8 may store data indicative of an extent to which an autonomous vehicle (and/or particular feature thereof) is capable of manual override.

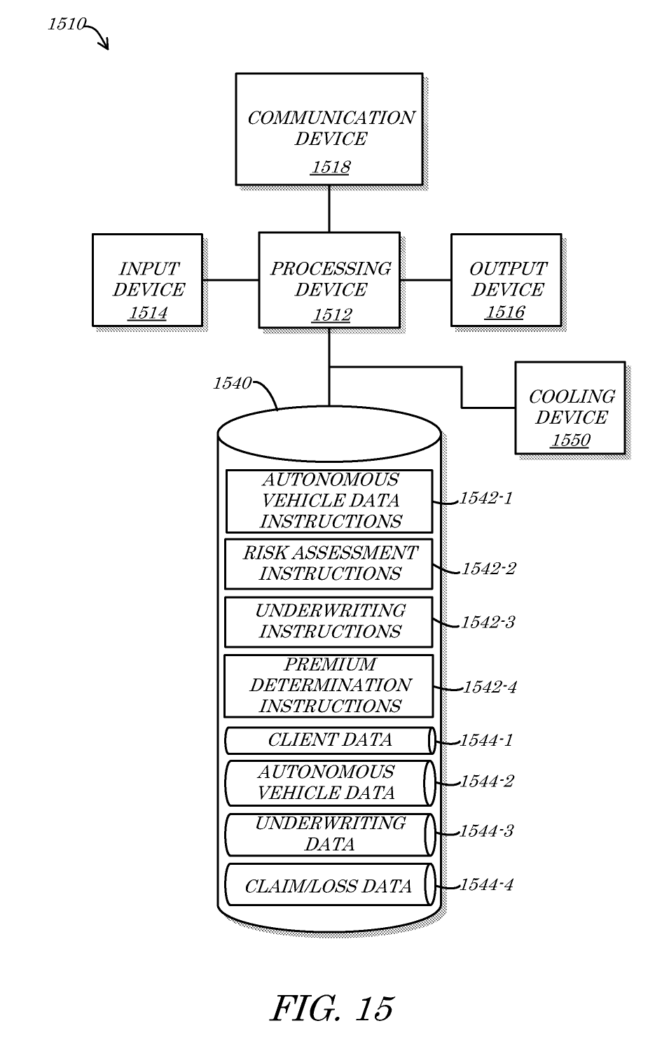

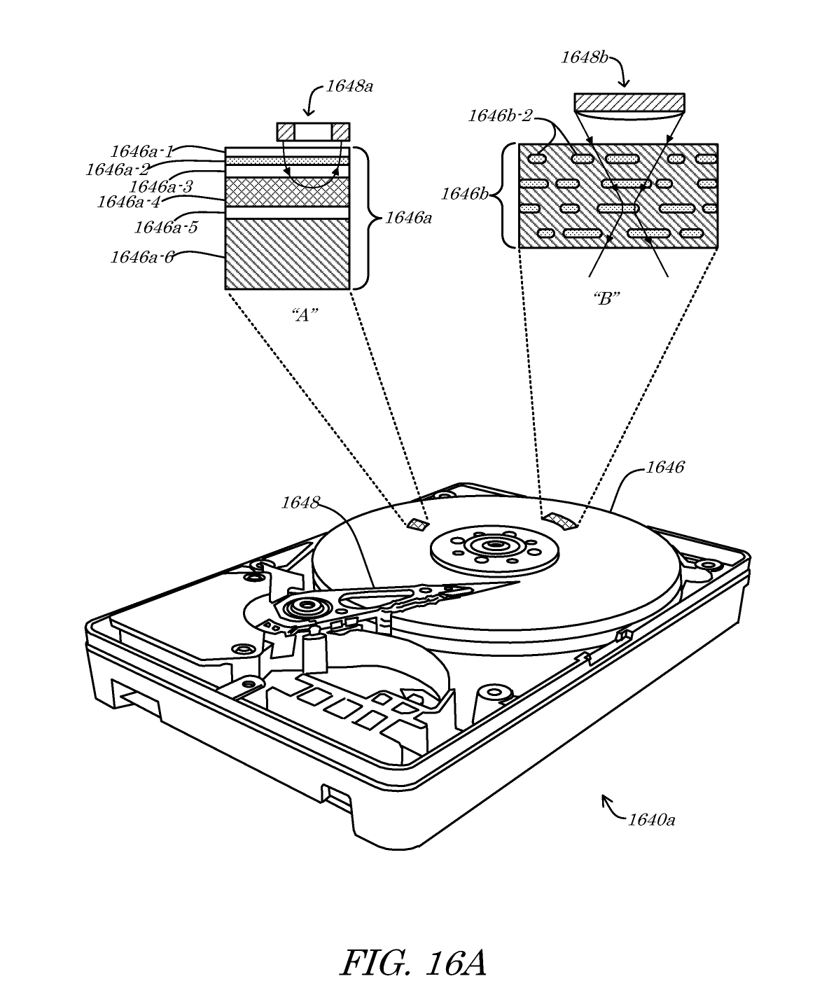

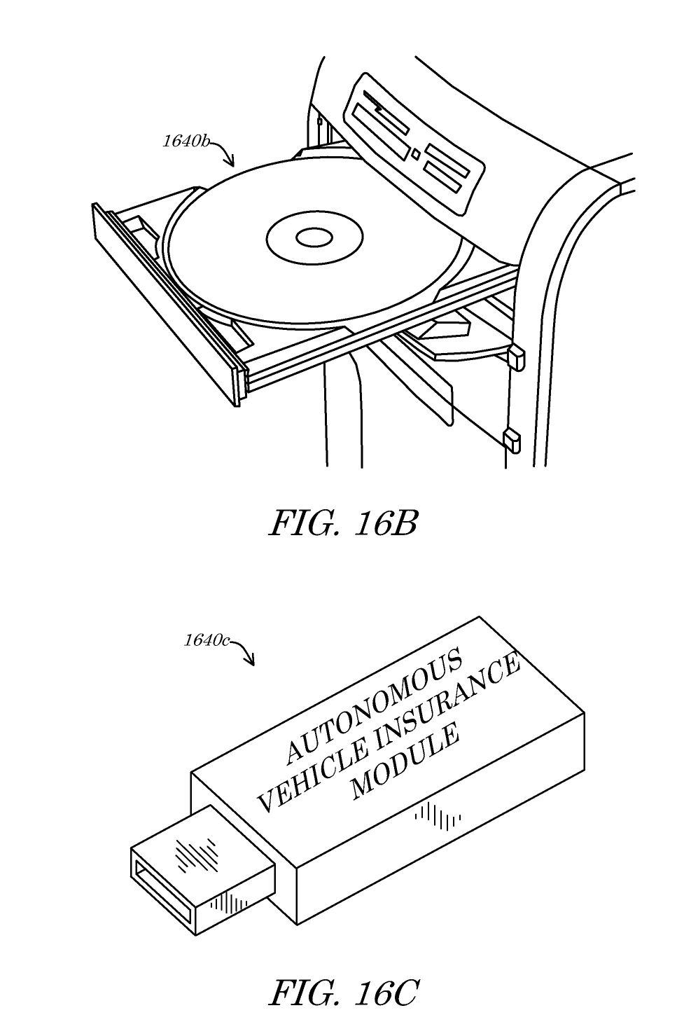

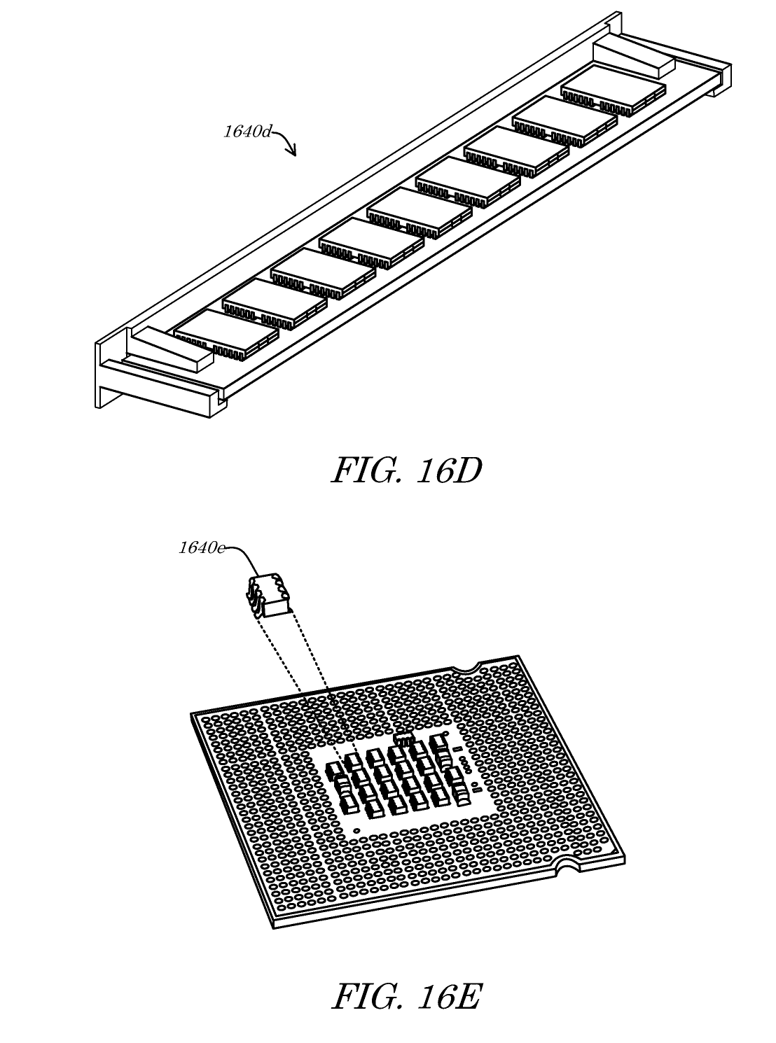

The autonomous vehicle factor table 844b may comprise, in accordance with some embodiments, an autonomous vehicle factor score field 844b-1 and/or a modifier field 844b-2. In some embodiments, some or all of the data stored in the autonomous vehicle factor score field 844b-1 may be derived, calculated, and/or otherwise determined based on some or all of the data stored in the autonomous vehicle data table 844a. Data from the autonomous vehicle data table 844a may, for example, be processed by a device (such as the controller device 1010 of FIG. 10 and/or the processing device 1512 of FIG. 15) to determine and/or store (e.g., in a memory device 1540, 1640a-e of FIG. 15, FIG. 16A, FIG. 16B, FIG. 16. C, FIG. 16D, and/or FIG. 16E herein) a metric, score, rank, and/or value in the autonomous vehicle factor score field 844b-1. In some embodiments, the autonomous vehicle factor score field 844b-1 may store an indication of an extent to which a vehicle's level of automation should affect insurance processing. A corresponding value stored in the modifier field 844b-2 may, for example, be utilized to adjust a risk rating (e.g., a “risk modifier”), insurance premium (e.g., a “premium modifier”), and/or other underwriting parameter (e.g., an insurance parameter modifier”) associated with an autonomous vehicle. According to some embodiments, the data tables 844a-b may be utilized to store and/or utilize data with respect to a plurality of vehicles, households, customers, accounts, policies, etc. The data stored in the data tables 844a-b may, for example, be utilized to conduct processes with respect to a fleet and/or other group or plurality of vehicles.

In some embodiments, fewer or more data fields than are shown may be associated with the data tables 844a-b. Only a portion of one or more databases and/or other data stores is necessarily shown in any of FIG. 8, for example, and other database fields, columns, structures, orientations, quantities, and/or configurations may be utilized without deviating from the scope of some embodiments. Further, the data shown in the various data fields is provided solely for exemplary and illustrative purposes and does not limit the scope of embodiments described herein nor imply that any such data is accurate.

Turning now to FIG. 9, a flow diagram of a method 900 according to some embodiments is shown. In some embodiments, the method 900 may be implemented, facilitated, and/or performed by or otherwise associated with the system 1000 of FIG. 10 herein (and/or portions thereof, such as the controller device 1010). In some embodiments, the method 900 may be associated with the methods 1100, 1200, 1300 of FIG. 11, FIG. 12, and/or FIG. 13. The method 900 may, for example, comprise a portion of the method 1100 such as the autonomous vehicle data processing 1110, the underwriting 1120, and/or the insurance policy quote and issuance 1150. In some embodiments, the method 900 may be illustrative of a process in which a standard determination (e.g., risk assessment, underwriting, pricing, quotation, sales, and/or claims) is conducted and then modified to account for autonomous vehicle parameters.

The process diagrams and flow diagrams described herein do not necessarily imply a fixed order to any depicted actions, steps, and/or procedures, and embodiments may generally be performed in any order that is practicable unless otherwise and specifically noted. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the data storage devices 840, 1540, 1640a-e of FIG. 8, FIG. 15, FIG. 16A, FIG. 16B, FIG. 16C, FIG. 16D, and/or FIG. 16E herein) may store thereon instructions that when executed by a machine (such as a computerized processor) result in performance according to any one or more of the embodiments described herein.

According to some embodiments, the method 900 may comprise determining (e.g., by a processing device) a level of automation of a vehicle, at 902. Various data descriptive of one or more vehicles (e.g., a single vehicle or a group of vehicles, such as multiple vehicles for a single family or a fleet of vehicles for a commercial customer) may, for example, be received and/or collected from a variety of sources. An insurance customer (e.g., a current customer and/or a potential customer) may provide (and/or a server may receive in response thereto) data descriptive of the customer's vehicle(s), in some embodiments, and/or data may be received from a third-party, such as a Department of Motor Vehicles (DMV), a vehicle manufacturer, and/or an investigative entity (e.g., a vehicle inspection report). In some embodiments, data may be received from the vehicle, such as from one or more vehicle communication and/or telematics devices, and/or may be retrieved from one or more databases.

In some embodiments, the data may be descriptive of a plurality of autonomous vehicle parameters and/or variables. The data may indicate, for example, that a particular vehicle comprises anti-lock brakes (e.g., a basic safety feature 128d-1 of FIG. 1 and/or a safety feature 228d of FIG. 2), automatic parallel parking (e.g., an advanced convenience feature 128b-2 of FIG. 1 and/or a convenience feature 228e of FIG. 2), and a lane departure warning system (e.g., a warning system 128c of FIG. 1 and/or a warning feature 228c of FIG. 2). According to some embodiments, each such determined autonomous vehicle variable may be scored, weighted, and/or ranked. It may be determined, for example, that the lane departure warning system is likely to reduce the occurrence of accidents to some degree and/or with some level of probability, while the automatic parallel parking feature may be determined to have no effect on overall vehicle safety but may be associated with high levels of loss (e.g., repair or replacement cost) upon occurrence of accident events.

One or more scores, weighting factors, and/or metrics descriptive of these determined effects may be determined and/or calculated (e.g., “scoring factors”). In some embodiments, such scores, factors, and/or metrics may be determined for each insurance type and/or each insurance component type associated with insurance coverage for the autonomous vehicle (e.g., auto liability, physical damage, and/or general liability). In some embodiments, the level of automation may be descriptive of one or more of (i) an effectiveness of one or more autonomous vehicle features, (ii) a measure of how autonomous a vehicle is (e.g., a percent of total vehicle features that are autonomous-related), (iii) a measure of how many autonomous vehicle features are utilized (e.g., which features a driver utilizes and/or which features are not utilized), and/or (iv) a measure of how often autonomous vehicle features are utilized (e.g., a percentage of time that a driver utilizes a vehicle in autonomous mode and/or a total experience level or time with respect to the driver and/or vehicle and autonomous feature usage). In some embodiments, the level of automation for the vehicle may comprise a level of automation for a plurality of vehicles such as a commercial fleet of vehicles, a household of vehicles, and/or other groups of vehicles.

According to some embodiments, the scores and/or other values descriptive of the autonomous vehicle variables may be summed, combined, aggregated, and/or otherwise processed to determine a modifier metric for the vehicle(s). A total overall autonomous vehicle variable score may be compared to one or more thresholds and/or ranges of scores (e.g., stored in the autonomous vehicle factor score field 844b-1 of the autonomous vehicle factor table 844b of FIG. 8), for example, to determine a modifier metric and/or value (e.g., stored in a corresponding record of the modifier field 844b-2 of the autonomous vehicle factor table 844b of FIG. 8).

In some embodiments, the method 900 may comprise determining (e.g., by the processing device and/or based on the level of automation of the vehicle), a risk assessment for the vehicle, at 904. The level of automation of the vehicle(s) may be utilized, for example, to inform a risk assessment determination for the vehicle(s). According to some embodiments, the scores and/or modifier metric determined at 902 may be utilized to modify and/or inform a risk assessment determination. A standard risk assessment for an insurance policy may be determined based on traditional and/or non-autonomous vehicle factors, for example, such as driver accident history, driver age, vehicle make, color, etc. In some embodiments, such a risk assessment may be modified based on the determined level of automation of the vehicle. In the case that the risk assessment comprises a numeric value such as a risk score, for example, the modifier determined based on the level of automation of the vehicle may be utilized as a multiplier and/or weighting factor to alter the base risk assessment. In such a manner, for example, a standard or base risk assessment may be scaled or weighted to reflect expected risk levels associated with the autonomous vehicle.

As an example, the following formula (1) may be utilized to scale a standard or base risk assessment/score to reflect the level of vehicle automation:

$$AVRS = RS * {\sum }_{1 - n} ( {RF}_{n} * {C}_{n} * {ADJ}_{n} ) , \qquad ( 1 )$$

where “AVRS” is the autonomous vehicle risk score (or modified risk score), “RS” is the standard or base risk score, “n” is the number of autonomous vehicle variables considered, “RF” is a risk factor associated with a particular autonomous vehicle variable, “C” is a repair and/or replacement cost and/or cost factor associated with the particular autonomous vehicle variable, and “ADJ” is a manual override adjustment factor. While formula (1) relies on multiplication of the listed variables, it should be understood that other mathematical processes for combining and/or scaling variables may be utilized without deviation from the scope of some embodiments.

According to some embodiments, the method 900 may comprise determining (e.g., by the processing device), based on the risk assessment of the vehicle, an insurance parameter for the vehicle, at 906. The insurance parameter may comprise, for example, an insurance premium, quote, discount, and/or surcharge. In some embodiments, such as in the case that the risk assessment takes into account the level of automation of the autonomous vehicle, the insurance parameter may simply be determined therefrom (e.g., via an underwriting process such as at 1120 of FIG. 11). According to some embodiments, the insurance parameter may be modified based on the level of automation of the autonomous vehicle (e.g., determined at 902). In the case that the risk assessment does not take into account autonomous vehicle variables, for example, the modifier determined at 902 may be utilized to alter and/or inform the definition of the insurance parameter. In the case that an autonomous vehicle feature/variable is determined to have little effect on risk, for example (e.g., and accordingly does not warrant an alteration of the risk assessment), but significantly increases the physical damage repair costs of the vehicle (e.g., an expensive convenience feature), a modifier may be applied to a determined insurance premium to account for the expected higher loss cost for the vehicle (e.g., a surcharge).

As an example, the following formula (2) may be utilized to scale a standard, base, and/or original and/or initial premium to reflect the level of vehicle automation:

$$AVP = P * {\sum }_{1 - n} ( {LRF}_{n} * {PDRF}_{n} * {C}_{n} * {ADJ}_{n} ) , \qquad ( 2 )$$

where “AVP” is the autonomous vehicle premium (or modified premium), “P” is the standard/base/original/initial premium, “n” is the number of autonomous vehicle variables considered, “LRF” is a liability reduction factor associated with a particular autonomous vehicle variable, “PDRF” is a physical damage reduction factor associated with a particular autonomous vehicle variable, “C” is the repair and/or replacement cost and/or cost factor associated with the particular autonomous vehicle variable, and “ADJ” is the manual override adjustment factor. While formula (2) relies on multiplication of the listed variables, it should be understood that other mathematical processes for combining and/or scaling variables may be utilized without deviation from the scope of some embodiments.

In some embodiments, the factors utilized in the equations (1) and/or (2) may be similar to or comprise the modifier determined at 902 (e.g., a value stored in the modifier field 844b-2 of the autonomous vehicle factor table 844b of FIG. 8). The level of automation determined at 902 may yield one or more autonomous vehicle scores, factors, and/or ratings, for example, that may be utilized to determine the factors utilized in the equations (1) and/or (2) to determine a modified risk score value and/or a modified insurance parameter value (e.g., a modified premium).

According to some embodiments, the method 900 may comprise causing (e.g., by the processing device) an outputting of an indication of the insurance parameter for the vehicle, at 908. The insurance parameter may, for example, be output via a display device, provided to one or more user display devices via a webpage, and/or transmitted to one or more user devices. In some embodiments, the outputting may comprise causing an application on a user's mobile device to output a Graphical User Interface (GUI) comprising a human-readable indication of the insurance parameter (and/or a value thereof). In some embodiments, some or all of the autonomous vehicle data/variables utilized to define the insurance parameter may also or alternatively be output (and/or caused to be output).

Referring now to FIG. 10, a block diagram of a system 1000 according to some embodiments is shown. In some embodiments, the system 1000 may comprise a plurality of user devices 1002a-n, a network 1004, a third-party device 1006, and/or a controller device 1010. As depicted in FIG. 10, any or all of the devices 1002a-n, 1006, 1010 (or any combinations thereof) may be in communication via the network 1004. In some embodiments, the system 1000 may be utilized to provide (and/or receive) customer data, vehicle data, autonomous vehicle data, and/or other data or metrics. The controller device 1010 may, for example, interface with one or more of the user devices 1002a-n and/or the third-party device 1006 to acquire, gather, aggregate, process, and/or utilize autonomous vehicle data and/or other data or metrics in accordance with embodiments described herein.

Fewer or more components 1002a-n, 1004, 1006, 1010 and/or various configurations of the depicted components 1002a-n, 1004, 1006, 1010 may be included in the system 1000 without deviating from the scope of embodiments described herein. In some embodiments, the components 1002a-n, 1004, 1006, 1010 may be similar in configuration and/or functionality to similarly named and/or numbered components as described herein. In some embodiments, the system 1000 (and/or portion thereof) may comprise a risk assessment and/or underwriting program and/or platform programmed and/or otherwise configured to execute, conduct, and/or facilitate any of the various methods 900, 1100, 1200, 1300 of FIG. 9, FIG. 11, FIG. 12, and/or FIG. 13 and/or portions or combinations thereof described herein.

The user devices 1002a-n, in some embodiments, may comprise any types or configurations of computing, mobile electronic, network, user, and/or communication devices that are or become known or practicable. The user devices 1002a-n may, for example, comprise one or more PC devices, computer workstations (e.g., claim adjuster and/or handler and/or underwriter workstations), tablet computers such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, the user devices 1002a-n may comprise devices owned and/or operated by one or more users such as underwriters, account managers, agents/brokers, customer service representatives, data acquisition partners and/or consultants or service providers, and/or underwriting product customers. According to some embodiments, the user devices 1002a-n may communicate with the controller device 1010 via the network 1004, such as to conduct risk assessment and/or underwriting inquiries and/or processes utilizing autonomous vehicle data as described herein.

In some embodiments, the user devices 1002a-n may interface with the controller device 1010 to effectuate communications (direct or indirect) with one or more other user devices 1002a-n (such communication not explicitly shown in FIG. 10), such as may be operated by other users. In some embodiments, the user devices 1002a-n may interface with the controller device 1010 to effectuate communications (direct or indirect) with the third-party device 1006 (such communication also not explicitly shown in FIG. 10). In some embodiments, the user devices 1002a-n and/or the third-party device 1006 may comprise one or more sensors configured and/or coupled to sense, measure, calculate, and/or otherwise process or determine autonomous vehicle data. In some embodiments, such sensor data may be provided to the controller device 1010, such as for utilization of the autonomous vehicle data in pricing, risk assessment, line and/or limit setting, quoting, and/or selling or re-selling of an underwriting product.

The network 1004 may, according to some embodiments, comprise a Local Area Network (LAN; wireless and/or wired), cellular telephone, Bluetooth®, and/or Radio Frequency (RF) network with communication links between the Ocontroller device 110, the user devices 1002a-n, and/or the third-party device 1006. In some embodiments, the network 1004 may comprise direct communications links between any or all of the components 1002a-n, 1006, 1010 of the system 1000. The user devices 1002a-n may, for example, be directly interfaced or connected to one or more of the controller device 1010 and/or the third-party device 1006 via one or more wires, cables, wireless links, and/or other network components, such network components (e.g., communication links) comprising portions of the network 1004. In some embodiments, the network 1004 may comprise one or many other links or network components other than those depicted in FIG. 10. The user devices 1002a-n may, for example, be connected to the controller device 1010 via various cell towers, routers, repeaters, ports, switches, and/or other network components that comprise the Internet and/or a cellular telephone (and/or Public Switched Telephone Network (PSTN)) network, and which comprise portions of the network 1004.

While the network 1004 is depicted in FIG. 10 as a single object, the network 1004 may comprise any number, type, and/or configuration of networks that is or becomes known or practicable. According to some embodiments, the network 1004 may comprise a conglomeration of different sub-networks and/or network components interconnected, directly or indirectly, by the components 1002a-n, 1006, 1010 of the system 1000. The network 1004 may comprise one or more cellular telephone networks with communication links between the user devices 1002a-n and the controller device 1010, for example, and/or may comprise the Internet, with communication links between the controller device 1010 and the third-party device 1006, for example.

The third-party device 1006, in some embodiments, may comprise any type or configuration a computerized processing device such as a PC, laptop computer, computer server, database system, and/or other electronic device, devices, or any combination thereof. In some embodiments, the third-party device 1006 may be owned and/or operated by a third-party (i.e., an entity different than any entity owning and/or operating either the user devices 1002a-n or the controller device 1010). The third-party device 1006 may, for example, be owned and/or operated by a service provider such as a data and/or data service provider. In some embodiments, the third-party device 1006 may comprise a data source and/or supply and/or provide data such as autonomous vehicle data and/or other data to the controller device 1010 and/or the user devices 1002a-n. The third-party device 1006 may, for example, comprise a vehicle data information source and/or device, such as a third-party vehicle information provider, a vehicle manufacturer, a vehicle seller and/or distributor, etc. In some embodiments, the third-party device 1006 may comprise a plurality of devices and/or may be associated with a plurality of third-party entities.

In some embodiments, the controller device 1010 may comprise an electronic and/or computerized controller device such as a computer server communicatively coupled to interface with the user devices 1002a-n and/or the third-party device 1006 (directly and/or indirectly). The controller device 1010 may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the controller device 1010 may be located remote from one or more of the user devices 1002a-n and/or the third-party device 1006. The controller device 1010 may also or alternatively comprise a plurality of electronic processing devices located at one or more various sites and/or locations.

According to some embodiments, the controller device 1010 may store and/or execute specially programmed instructions to operate in accordance with embodiments described herein. The controller device 1010 may, for example, execute one or more programs that facilitate the utilization of autonomous vehicle data in the processing, pricing, underwriting, and/or issuance of one or more insurance and/or underwriting products. According to some embodiments, the controller device 1010 may comprise a computerized processing device such as a PC, laptop computer, computer server, and/or other electronic device to manage and/or facilitate transactions and/or communications regarding the user devices 1002a-n. An underwriter (and/or customer, client, or company) may, for example, utilize the controller device 1010 to (i) assess the risk on one or more insurance products, (ii) price and/or underwrite one or more products such as insurance, indemnity, and/or surety products, (iii) determine and/or be provided with autonomous vehicle data and/or other information, (iv) assess a level, category, weight, score, and/or rank of automation for one or more vehicles, and/or (v) provide an interface via which an underwriting entity may manage and/or facilitate underwriting of various products (e.g., in accordance with embodiments described herein).

Referring now to FIG. 11, a flow diagram of a method 1100 according to some embodiments is shown. In some embodiments, the method 1100 may be performed and/or implemented by and/or otherwise associated with one or more specialized and/or specially-programmed computers (e.g., the user devices 1002a-n, the third-party device 1006, and/or the controller device 1010, all of FIG. 10), computer terminals, computer servers, computer systems and/or networks, and/or any combinations thereof (e.g., by one or more insurance company, risk assessment, product sales, and/or underwriter computers). In some embodiments, the method 1100 may be illustrative of a process in which determinations (e.g., risk assessment, underwriting, pricing, quotation, sales, and/or claims) intrinsically account for autonomous vehicle parameters.

According to some embodiments, the method 1100 may comprise one or more actions associated with autonomous vehicle data 1102a-n. The autonomous vehicle data 1102a-n of one or more objects and/or areas that may be related to and/or otherwise associated with an account, customer, vehicle, insurance product, and/or policy (and/or a claim thereof), for example, may be determined, calculated, looked-up, retrieved, and/or derived. In some embodiments, the autonomous vehicle data 1102a-n may be gathered as raw data directly from one or more data sources (e.g., the user devices 1002a-n of FIG. 1).

As depicted in FIG. 11, autonomous vehicle data 1102a-n from a plurality of data sources may be gathered. In some embodiments, the plurality of autonomous vehicle data 1102a-n may comprise information indicative of autonomous vehicle parameter values of a single object or area or may comprise information indicative of autonomous vehicle parameter values of a plurality of objects and/or areas and/or types of objects and/or areas. The autonomous vehicle data 1102a-n may, for example, be descriptive of various characteristics and/or features associated with an autonomous vehicle, such as any or all of the variables 220 of FIG. 2.

According to some embodiments, the method 1100 may also or alternatively comprise one or more actions associated with autonomous vehicle data processing 1110. As depicted in FIG. 11, for example, some or all of the autonomous vehicle data 1102a-n may be determined, gathered, transmitted and/or received, and/or otherwise obtained for autonomous vehicle data processing 1110. In some embodiments, autonomous vehicle data processing 1110 may comprise aggregation, analysis, calculation, storing (e.g., in a data storage structure such as the data storage devices 840, 1540, 1640a-e of FIG. 8, FIG. 15, FIG. 16A, FIG. 16B, FIG. 16C, FIG. 16D, and/or FIG. 16E herein), filtering, conversion, encoding and/or decoding (including encrypting and/or decrypting), sorting, ranking, de-duping, and/or any combinations thereof.

According to some embodiments, a processing device may execute specially programmed instructions to process (e.g., the autonomous vehicle data processing 1110) the autonomous vehicle data 1102a-n to define an autonomous vehicle risk metric and/or index. Such an autonomous vehicle risk metric may, for example, be descriptive (in a qualitative and/or quantitative manner) of historic, current, and/or predicted risk levels of an object and/or area having and/or being associated with one or more autonomous vehicle characteristics. In some embodiments, the autonomous vehicle risk metric may be time-dependent, time or frequency-based, and/or an average, mean, and/or other statistically normalized value (e.g., an index).

According to some embodiments, there may be a correlation between the risk level associated with a particular autonomous vehicle risk (and/or set of autonomous vehicle characteristics and/or variables) and other variables such as time of day, road type, road condition, road congestion, traffic patterns, and/or weather events when determining risk of loss. For example, a given risk level for an autonomous vehicle risk and/or characteristic may correlate to a higher risk when there is ice, snow, or heavy slush likely to occur, than when only rain is expected (e.g., certain autonomous vehicle features may be known to have a higher likelihood of malfunction due to exposure to freezing precipitation).

In some embodiments, the method 1100 may also or alternatively comprise one or more actions associated with insurance underwriting 1120. Insurance underwriting 1120 may generally comprise any type, variety, and/or configuration of underwriting process and/or functionality that is or becomes known or practicable. Insurance underwriting 1120 may comprise, for example, simply consulting a pre-existing rule, criteria, and/or threshold to determine if an insurance product may be offered, underwritten, and/or issued to clients, based on any relevant autonomous vehicle data 1102a-n. One example of an insurance underwriting 1120 process may comprise one or more of a risk assessment 1130 and/or a premium calculation 1140 (e.g., as shown in FIG. 11). In some embodiments, while both the risk assessment 1130 and the premium calculation 1140 are depicted as being part of an exemplary insurance underwriting 1120 procedure, either or both of the risk assessment 1130 and the premium calculation 1140 may alternatively be part of a different process and/or different type of process (and/or may not be included in the method 1100, as is or becomes practicable and/or desirable).

In some embodiments, the autonomous vehicle data 1102a-n may be utilized in the insurance underwriting 1120 and/or portions or processes thereof (the autonomous vehicle data 1102a-n may be utilized, at least in part for example, to determine, define, identify, recommend, and/or select a coverage type and/or limit and/or type and/or configuration of underwriting product). According to some embodiments, the autonomous vehicle data 1102a-n may be utilized as part of the insurance underwriting 1120 to define, formulate, identify, construct, and/or otherwise determine a preventative or action plan that may for example, be utilized as a condition (or guidelines) for an insurance policy and/or other underwriting product. A liability policy in general, or with respect to one or more specific objects and/or activities for example, may be governed by the preventative plan which may include details regarding requirements for preventative maintenance measures required for certain autonomous vehicle features, devices, and/or systems.

In some embodiments, the autonomous vehicle data 1102a-n and/or a result of autonomous vehicle data processing 1110 may be determined and utilized to conduct the risk assessment 1130 for any of a variety of purposes. In some embodiments, the risk assessment 1130 may be conducted as part of a rating process for determining how to structure an insurance product and/or offering. A “rating engine” utilized in an insurance underwriting process may, for example, retrieve an autonomous vehicle risk metric (e.g., provided as a result of the autonomous vehicle data processing 1110) for input into a calculation (and/or series of calculations and/or a mathematical model) to determine a level of risk or the amount of risky behavior likely to be associated with a particular object, event, activity, and/or area (e.g., being associated with one or more particular autonomous vehicle characteristics and/or variables). In some embodiments, the risk assessment 1130 may comprise determining that a client implements a certain preventative plan. In some embodiments, the risk assessment 1130 (and/or the method 1100) may comprise providing risk control recommendations (e.g., recommendations and/or suggestions directed to reduction of risk, premiums, loss, etc.), such as general or specific guidance and/or a preventative plan (whether formally tied to a policy as a requirement/condition or not).

In some embodiments, the risk assessment 1130 may comprise an initial, standard, and/or base risk score determination and a modification (e.g., application of a multiplier and/or factor) thereof to account for the autonomous vehicle data 1102a-n (e.g., such as at 904 of the method 900 of FIG. 9 herein). In some embodiments, the risk assessment 1130 may comprise a determination and/or analysis or processing of one or more relationships and/or trends among various variables. Some or all of the autonomous vehicle data 1102a-n may, for example, be determined to have a relationship with one or more other variables such as time of day, road type, road condition, road congestion, traffic patterns, and/or weather events (and/or any combinations thereof).

According to some embodiments, the method 1100 may also or alternatively comprise one or more actions associated with premium calculation 1140 (e.g., which may be part of the insurance underwriting 1120). In the case that the method 1100 comprises the insurance underwriting 1120 process, for example, the premium calculation 1140 may be utilized by a “pricing engine” to calculate (and/or look-up or otherwise determine) an appropriate premium to charge for an insurance policy associated with the object, activity, event, and/or area for which the autonomous vehicle data 1102a-n was collected and for which the risk assessment 1130 was performed. In some embodiments, the object, activity, event, and/or area analyzed may comprise an object, activity, event, and/or area for which an insurance product is sought (e.g., the analyzed activity may comprise operation of a particular vehicle for which a liability and/or physical damage insurance policy is desired). According to some embodiments, the object, activity, event, and/or area analyzed may be an object, activity, event, and/or area other than the object, activity, event, and/or area for which insurance is sought (e.g., the analyzed object may comprise a roadway—on which autonomous vehicles operate—in proximity to a location associated with an insurance policy). In some embodiments, the premium calculation 1140 may comprise an initial, standard, and/or base premium determination and a modification (e.g., application of a multiplier and/or factor) thereof to account for the autonomous vehicle data 1102a-n (e.g., such as at 906 of the method 900 of FIG. 9 herein). In some embodiments, the premium calculation 1140 may comprise determining one or more discounts, surcharges, and/or other modifiers associated with and/or based on the autonomous vehicle data 1102a-n (and/or the processing thereof at 1110).

According to some embodiments, the method 1100 may also or alternatively comprise one or more actions associated with insurance policy quote and/or issuance 1150. Once a policy has been rated, priced, or quoted and the client has accepted the coverage terms (e.g., a preventative plan based on the autonomous vehicle data 1102a-n), the insurance company may, for example, bind and issue the policy by hard copy and/or electronically to the client/insured. In some embodiments, the quoted and/or issued policy may comprise a personal insurance policy, such as a property damage and/or liability policy, and/or a business insurance policy, such as a business liability policy, and/or a property damage policy. According to some embodiments, one or more indications of policy details (e.g., quoted premium amount, surcharges, discounts, and/or terms) may be output to the customer/potential customer (e.g., such as at 908 of the method 900 of FIG. 9).

In general, a client/customer and/or insurance agent may visit a website, for example, and/or may provide the needed information about the client and type of desired insurance, and request an insurance policy and/or product. According to some embodiments, the insurance underwriting 1120 may be performed utilizing information about the potential client and the policy may be issued as a result thereof. Insurance coverage may, for example, be evaluated, rated, priced, and/or sold to one or more clients, at least in part, based on the autonomous vehicle data 1102a-n. In some embodiments, an insurance company may have the potential client indicate electronically, on-line, or otherwise whether they have any autonomous vehicle risk and/or location-sensing (e.g., telematics) devices (and/or which specific devices they have) and/or whether they are willing to install them or have them installed. In some embodiments, this may be done by check boxes, radio buttons, or other form of data input/selection, on a web page and/or via a mobile device application.

In some embodiments, the method 1100 may comprise telematics data gathering, at 1152. In the case that a client desires to have telematics data monitored, recorded, and/or analyzed, for example, not only may such a desire or willingness affect policy pricing (e.g., affect the premium calculation 1140), but such a desire or willingness may also cause, trigger, and/or facilitate the transmitting and/or receiving, gathering, retrieving, and/or otherwise obtaining autonomous vehicle data 1102a-n from one or more telematics devices. As depicted in FIG. 11, results of the telematics data gathering at 1152 may be utilized to affect the autonomous vehicle data processing 1110, the risk assessment 1130, and/or the premium calculation 1140 (and/or otherwise may affect the insurance underwriting 1120). Telematics data may be utilized, for example, to determine whether a preventative plan is being properly implemented and/or whether the preventative plan is adequate given the particular autonomous vehicle data 1102a-n associated with a particular object, activity, event, and/or area.

According to some embodiments, the method 1100 may also or alternatively comprise one or more actions associated with claim processing 1160. In the insurance context, for example, after an insurance product is provided and/or policy is issued (e.g., via the insurance policy quote and issuance 1150), and/or during or after telematics data gathering 1152, one or more insurance claims may be filed against the product/policy. In some embodiments, such as in the case that a first object associated with the insurance policy is somehow involved with one or more insurance claims, the autonomous vehicle data 1102a-n of the object or related objects may be gathered and/or otherwise obtained. According to some embodiments, such autonomous vehicle data 1102a-n may comprise data indicative of a level of risk of the object and/or area (or area in which the object was located) at the time of casualty or loss (e.g., as defined by the one or more claims). Information on claims may be provided to the autonomous vehicle data processing 1110, risk assessment 1130, and/or premium calculation 1140 to update, improve, and/or enhance these procedures and/or associated software and/or devices. In some embodiments, autonomous vehicle data 1102a-n may be utilized to determine, inform, define, and/or facilitate a determination or allocation of responsibility related to a loss (e.g., the autonomous vehicle data 1102a-n may be utilized to determine an allocation of weighted liability among those involved in the incident(s) associated with the loss and/or otherwise determine a claim action). Particularly in the case of an autonomous vehicle, for example, such a vehicle may be equipped with various sensors, data recording devices, and/or stored logic that may assist (if not drive and/or define) the claims handling process. An autonomous vehicle may, for example, allow claim handling determinations based on data acquired and/or stored by the autonomous vehicle immediately prior to, during, and/or after an accident.

In some embodiments, the method 1100 may also or alternatively comprise insurance policy renewal review 1170. Autonomous vehicle data 1102a-n may be utilized, for example, to determine if and/or how an existing insurance policy (e.g., provided via the insurance policy quote and issuance 1150) may be renewed. According to some embodiments, such as in the case that a client is involved with and/or in charge of (e.g., responsible for) providing the autonomous vehicle data 1102a-n (e.g., such as autonomous vehicle capabilities, features, maintenance records, and/or performance data), a review may be conducted to determine if the correct amount, frequency, and/or type or quality of the autonomous vehicle data 1102a-n was indeed provided by the client during the original term of the policy. In the case that the autonomous vehicle data 1102a-n was lacking (and/or indicative of a violation of a preventative plan established for the policy), the policy may not, for example, be renewed and/or any discount received by the client for providing the autonomous vehicle data 1102a-n may be revoked or reduced. In some embodiments, the client may be offered a discount for having certain sensing devices or being willing to install them or have them installed (or be willing to adhere to certain thresholds based on measurements from such devices, e.g., in accordance with a preventative plan such as an autonomous vehicle feature preventative maintenance plan). In some embodiments, analysis of the received autonomous vehicle data 1102a-n in association with the policy may be utilized to determine if the client conformed to various criteria and/or rules set forth in the original policy. In the case that the client satisfied applicable policy requirements (e.g., as verified by received autonomous vehicle data 1102a-n), the policy may be eligible for renewal and/or discounts. In the case that deviations from policy requirements are determined (e.g., based on the autonomous vehicle data 1102a-n), the policy may not be eligible for renewal, a different policy may be applicable, and/or one or more surcharges and/or other penalties may be applied.

According to some embodiments, the method 1100 may comprise one or more actions associated with risk/loss control 1180. Any or all data (e.g., autonomous vehicle data 1102a-n and/or other data) gathered as part of a process for claims processing 1160, for example, may be gathered, collected, and/or analyzed to determine how (if at all) one or more of a rating engine (e.g., the risk assessment 1130), a pricing engine (e.g., the premium calculation 1140), the insurance underwriting 1120, and/or the autonomous vehicle data processing 1110, should be updated to reflect actual and/or realized risk, costs, and/or other issues associated with the autonomous vehicle data 1102a-n. Results of the risk/loss control 1180 may, according to some embodiments, be fed back into the method 1100 to refine the risk assessment 1130, the premium calculation 1140 (e.g., for subsequent insurance queries and/or calculations), the insurance policy renewal review 1170 (e.g., a re-calculation of an existing policy for which the one or more claims were filed), and/or the autonomous vehicle data processing 1110 to appropriately scale the output of the risk assessment 1130.

In some embodiments, the method 1100 may comprise a provision of various services such as pricing, underwriting, servicing, marketing, and/or making recommendations (e.g., risk, marketing, and/or other recommendations), e.g., based on autonomous vehicle data 1102a-n.

Turning now to FIG. 12, a flow diagram of a method 1200 according to some embodiments is shown. In some embodiments, the method 1200 may comprise an autonomous vehicle-based risk assessment method which may, for example, be described as a “rating engine”. According to some embodiments, the method 1200 may be implemented, facilitated, and/or performed by or otherwise associated with the system 1000 of FIG. 10. In some embodiments, the method 1200 may be associated with the methods 900, 1100 of FIG. 9 and/or FIG. 11 and/or portions or combinations thereof. The method 1200 may, for example, comprise a portion of the method 900 such as the determining of the risk assessment at 904 and/or a portion of the method 1100, such as the risk assessment 1130.

According to some embodiments, the method 1200 may comprise determining one or more loss frequency distributions for a class of objects, at 1202 (e.g., 1202a-b). In some embodiments, a first loss frequency distribution may be determined, at 1202a, based on autonomous vehicle metrics. Autonomous vehicle metrics (such as the autonomous vehicle data 1102a-n of FIG. 11) for a class of objects or actions, such as a class of property or type of activity and/or for a particular type of object (such as a particular model of autonomous vehicle) or a particular type of activity (such as highway driving) within a class of objects/activates may, for example, be analyzed to determine relationships between various autonomous vehicle metrics and empirical data descriptive of actual insurance losses for such object/activity types and/or classes of objects/activities. An autonomous vehicle risk processing and/or analytics system and/or device (e.g., the controller device 1010 (or components thereof) as described with respect to FIG. 10) may, according to some embodiments, conduct regression and/or other mathematical analysis on various autonomous vehicle risk metrics to determine and/or identify mathematical relationships that may exist between such metrics and actual sustained losses and/or casualties.

Similarly, at 1202b, a second loss frequency distribution may be determined based on non-autonomous vehicle metrics. According to some embodiments, the determining at 1202b may comprise a standard or typical loss frequency distribution utilized by an entity (such as an insurance company) to assess risk. The non-autonomous vehicle metrics utilized as inputs in the determining at 1202b may include, for example, age of a driver, gender of a driver, driving history (of a driver and/or vehicle), etc. In some embodiments, the loss frequency distribution determinations at 1202a-b may be combined and/or determined as part of a single comprehensive loss frequency distribution determination. In such a manner, for example, expected total loss probabilities (e.g., taking into account both autonomous vehicle metrics and non-autonomous vehicle metrics) for a particular object and/or activity type and/or class may be determined. In some embodiments, this may establish and/or define a baseline, datum, average, and/or standard with which individual and/or particular risk assessments may be measured.

According to some embodiments, the method 1200 may comprise determining one or more loss severity distributions for a class of objects, at 1204 (e.g., 1204a-b). In some embodiments, a first loss severity distribution may be determined, at 1204a, based on autonomous vehicle metrics. Autonomous vehicle data (such as the autonomous vehicle data 1102a-n of FIG. 11) for a class of objects and/or activities, such as driving activities and/or for a particular type of object/activity (such as pleasure/private versus commercial driving) may, for example, be analyzed to determine relationships between various autonomous vehicle metrics and empirical data descriptive of actual insurance losses for such object/activity types and/or classes of objects/activities. An autonomous vehicle risk processing and/or analytics system (e.g., the controller device 1010 (or components thereof) as described with respect to FIG. 10 herein) may, according to some embodiments, conduct regression and/or other analysis on various (e.g., autonomous vehicle) metrics to determine and/or identify mathematical relationships that may exist between such metrics and actual sustained losses and/or casualties.

Similarly, at 1204b, a second loss severity distribution may be determined based on non-autonomous vehicle metrics. According to some embodiments, the determining at 1204b may comprise a standard or typical loss severity distribution utilized by an entity (such as an insurance agency) to assess risk. The non-autonomous vehicle metrics utilized as inputs in the determining at 1204b may include, for example, vehicle cost, parts costs, vehicle repair labor costs, etc. In some embodiments, the loss severity distribution determinations at 1204a-b may be combined and/or determined as part of a single comprehensive loss severity distribution determination. In such a manner, for example, expected total loss severities (e.g., taking into account both autonomous vehicle metrics and non-autonomous vehicle metrics) for a particular object and/or activity type and/or class may be determined. In some embodiments, this may also or alternatively establish and/or define a baseline, datum, average, and/or standard with which individual and/or particular risk assessments may be measured.

In some embodiments, the method 1200 may comprise determining one or more expected loss frequency distributions for a specific object and/or activity (and/or account or other group of objects or activities, such as a list of activities likely or expected in relation to a specific project) in the class of objects/activities, at 1206 (e.g., 1206a-b). Regression and/or other mathematical analysis performed on the autonomous vehicle loss frequency distribution derived from empirical data, at 1202a for example, may identify various autonomous vehicle risk metrics and may mathematically relate such metrics to expected loss occurrences (e.g., based on historical trends). Based on these relationships, an autonomous vehicle loss frequency distribution may be developed at 1206a for the specific object and/or activity (and/or account or other group or list of objects or activities). In such a manner, for example, known autonomous vehicle risk metrics for a specific object and/or activity (and/or account or other group or list of objects or activities) may be utilized to develop an expected distribution (e.g., probability) of occurrence of autonomous vehicle-related loss for the specific object and/or activity (and/or account or other group or list of objects or activities).

Similarly, regression and/or other mathematical analysis performed on the non-autonomous vehicle loss frequency distribution derived from empirical data, at 1202b for example, may identify various non-autonomous vehicle metrics and may mathematically relate such metrics to expected loss occurrences (e.g., based on historical trends). Based on these relationships, a non-autonomous vehicle loss frequency distribution may be developed at 1206b for the specific object and/or activity (and/or account or other group of objects or activities, such as a list of activities likely or expected in relation to a specific project). In such a manner, for example, known non-autonomous vehicle metrics for a specific object and/or activity (and/or account or other group or list of objects or activities) may be utilized to develop an expected distribution (e.g., probability) of occurrence of non-autonomous vehicle-related loss for the specific object and/or activity (and/or account or other group or list of objects or activities). In some embodiments, the non-autonomous vehicle loss frequency distribution determined at 1206b may be similar to a standard or typical loss frequency distribution utilized by an insurer to assess risk.

In some embodiments, the method 1200 may comprise determining one or more expected loss severity distributions for a specific object and/or activity (and/or account or other group of objects or activities, such as a list of activities likely or expected in relation to a specific project) in the class of objects/activities, at 1208 (e.g., 1208a-b). Regression and/or other mathematical analysis performed on the autonomous vehicle loss severity distribution derived from empirical data, at 1204a for example, may identify various autonomous vehicle risk metrics and may mathematically relate such metrics to expected loss severities (e.g., based on historical trends). Based on these relationships, an autonomous vehicle loss severity distribution may be developed at 1208a for the specific object and/or activity (and/or account or other group or list of objects or activities). In such a manner, for example, known autonomous vehicle risk metrics for a specific object and/or activity (and/or account or other group or list of objects or activities) may be utilized to develop an expected severity for occurrences of autonomous vehicle-related loss for the specific object and/or activity (and/or account or other group or list of objects or activities).

Similarly, regression and/or other mathematical analysis performed on the non-autonomous vehicle loss severity distribution derived from empirical data, at 1204b for example, may identify various non-autonomous vehicle metrics and may mathematically relate such metrics to expected loss severities (e.g., based on historical trends). Based on these relationships, a non-autonomous vehicle loss severity distribution may be developed at 1208b for the specific object and/or activity (and/or account or other group or list of objects or activities). In such a manner, for example, known non-autonomous vehicle metrics for a specific object and/or activity (and/or account or other group or list of objects or activities) may be utilized to develop an expected severity of occurrences of non-autonomous vehicle-related loss for the specific object and/or activity (and/or account or other group or list of objects or activities). In some embodiments, the non-autonomous vehicle loss severity distribution determined at 1208b may be similar to a standard or typical loss frequency distribution utilized by an insurer to assess risk.

It should also be understood that the autonomous vehicle-based determinations 1202a, 1204a, 1206a, 1208a and non-autonomous vehicle-based determinations 1202b, 1204b, 1206b, 1208b are separately depicted in FIG. 12 for ease of illustration of one embodiment descriptive of how autonomous vehicle risk metrics may be included to enhance standard risk assessment procedures. According to some embodiments, the autonomous vehicle-based determinations 1202a, 1204a, 1206a, 1208a and non-autonomous vehicle-based determinations 1202b, 1204b, 1206b, 1208b may indeed be performed separately and/or distinctly in either time or space (e.g., they may be determined by different software and/or hardware modules or components and/or may be performed serially with respect to time). In some embodiments, autonomous vehicle-based determinations 1202a, 1204a, 1206a, 1208a and non-autonomous vehicle-based determinations 1202b, 1204b, 1206b, 1208b may be incorporated into a single risk assessment process or “engine” that may, for example, comprise a risk assessment software program, package, and/or module.

In some embodiments, the method 1200 may also comprise calculating a risk score (e.g., for an object, account, activity, event, and/or group or list of objects/activities, e.g., objects/activities related in a manner other than sharing an identical or similar class designation), at 1210. According to some embodiments, formulas, charts, and/or tables may be developed that associate various autonomous vehicle and/or non-autonomous vehicle metric magnitudes with risk scores. Risk scores for a plurality of autonomous vehicle and/or non-autonomous vehicle metrics may be determined, calculated, tabulated, and/or summed to arrive at a total risk score for an object, activity, event, and/or account (e.g., a vehicle, a vehicle feature, a fleet and/or group of vehicles and/or objects subject to autonomous vehicle risk) and/or for an object or activity class. According to some embodiments, risk scores may be derived from the autonomous vehicle and/or non-autonomous vehicle loss frequency distributions and the autonomous vehicle and/or non-autonomous vehicle loss severity distribution determined at 1206a-b and 1208a-b, respectively. More details on one method for assessing risk are provided in commonly-assigned U.S. Pat. No. 7,330,820 entitled “PREMIUM EVALUATION SYSTEMS AND METHODS,” which issued on Feb. 12, 2008, the risk assessment concepts and descriptions of which are hereby incorporated by reference herein. According to some embodiments, the method 1200 may comprise providing various services such as pricing, underwriting, servicing, marketing, and/or making recommendations (e.g., risk, marketing, and/or other recommendations), e.g., based on autonomous and/or non-autonomous vehicle data (and/or relationships there between).

In some embodiments, the method 1200 may also or alternatively comprise providing various recommendations, suggestions, guidelines, and/or rules directed to reducing and/or minimizing risk, premiums, etc. According to some embodiments, the results of the method 1200 may be utilized to determine a premium for an insurance policy for, e.g., a specific object, activity, project, and/or account analyzed. Any or all of the autonomous vehicle and/or non-autonomous vehicle loss frequency distributions of 1206a-b, the autonomous vehicle and/or non-autonomous vehicle loss severity distributions of 1208a-b, and the risk score of 1210 may, for example, be passed to and/or otherwise utilized by a premium calculation process via the node labeled “A” in FIG. 12.

Turning to FIG. 13, for example, a flow diagram of a method 1300 (that may initiate at the node labeled “A”) according to some embodiments is shown. In some embodiments, the method 1300 may comprise an autonomous vehicle-based premium determination method which may, for example, be described as a “pricing engine”. According to some embodiments, the method 1300 may be implemented, facilitated, and/or performed by or otherwise associated with the system 1000 of FIG. 10 herein. In some embodiments, the method 1300 may be associated with the methods 900, 1100 of FIG. 9 and/or FIG. 11 herein. The method 1300 may, for example, comprise a portion of the method 900, such as the determining of the insurance parameter at 906 and/or a portion of the method 1100, such as the premium calculation 1140. Any other technique for calculating an insurance premium that uses autonomous vehicle data described herein may be utilized, in accordance with some embodiments, as is or becomes practicable and/or desirable.

In some embodiments, the method 1300 may comprise determining a pure premium, at 1302. A pure premium is a basic, unadjusted premium that is generally calculated based on loss frequency and severity distributions. According to some embodiments, the autonomous vehicle and/or non-autonomous vehicle loss frequency distributions (e.g., from 1206a-b in FIG. 12) and the autonomous vehicle and/or non-autonomous vehicle loss severity distributions (e.g., from 1208a-b in FIG. 12) may be utilized to calculate a pure premium that would be expected, mathematically, to result in no net gain or loss for the insurer when considering only the actual cost of the loss or losses under consideration and their associated loss adjustment expenses. Determination of the pure premium may generally comprise simulation testing and analysis that predicts (e.g., based on the supplied frequency and severity distributions) expected total losses (autonomous vehicle-based and/or non-autonomous vehicle-based) over time.

According to some embodiments, the method 1300 may comprise determining an expense load, at 1304. The pure premium determined at 1302 does not take into account operational realities experienced by an insurer. The pure premium does not account, for example, for operational expenses such as overhead, staffing, taxes, fees, etc. Thus, in some embodiments, an expense load (or factor) is determined and utilized to take such costs into account when determining an appropriate premium to charge for an insurance product. According to some embodiments, the method 1300 may comprise determining a risk load, at 1306. The risk load is a factor designed to ensure that the insurer maintains a surplus amount large enough to produce an expected return for an insurance product.

According to some embodiments, the method 1300 may comprise determining a total premium, at 1308. The total premium may generally be determined and/or calculated by summing or totaling one or more of the pure premium, the expense load, and the risk load. In such a manner, for example, the pure premium is adjusted to compensate for real-world operating considerations that affect an insurer. In some embodiments, one or more of the pure premium or the total premium may be adjusted to account for autonomous vehicle variables. An autonomous vehicle modifier and/or factor may be applied to the total premium, for example, to produce a modified total premium (e.g., modified based on autonomous vehicle variables).

According to some embodiments, the method 1300 may comprise grading the total premium, at 1310. The total premium (and/or modified total premium) determined at 1308, for example, may be ranked and/or scored by comparing the total premium to one or more benchmarks. In some embodiments, the comparison and/or grading may yield a qualitative measure of the total premium. The total premium may be graded, for example, on a scale of “A”, “B”, “C”, “D”, and “F”, in order of descending rank. The rating scheme may be simpler or more complex (e.g., similar to the qualitative bond and/or corporate credit rating schemes determined by various credit ratings agencies such as Standard & Poor's (S&P) Financial service LLC, Moody's Investment Service, and/or Fitch Ratings from Fitch, Inc., all of New York, N.Y.) of as is or becomes desirable and/or practicable. More details on one method for calculating and/or grading a premium are provided in commonly-assigned U.S. Pat. No. 7,330,820 entitled “PREMIUM EVALUATION SYSTEMS AND METHODS” which issued on Feb. 12, 2008, the premium calculation and grading concepts and descriptions of which are hereby incorporated by reference herein.

According to some embodiments, the method 1300 may comprise outputting an evaluation, at 1312. In the case that the results of the determination of the total premium at 1308 are not directly and/or automatically utilized for implementation in association with an insurance product, for example, the grading of the premium at 1310 and/or other data such as the risk score determined at 1210 of FIG. 12 may be utilized to output an indication of the desirability and/or expected profitability of implementing the calculated premium. The outputting of the evaluation may be implemented in any form or manner that is or becomes known or practicable. One or more recommendations, graphical representations, visual aids, comparisons, and/or suggestions may be output, for example, to a device (e.g., a server and/or computer workstation) operated by an insurance underwriter and/or sales agent. One example of an evaluation comprises a creation and output of a risk matrix which may, for example, by developed utilizing Enterprise Risk Register® software which facilitates compliance with ISO 17799/ISO 27000 requirements for risk mitigation and which is available from Northwest Controlling Corporation Ltd. (NOWECO) of London, UK.

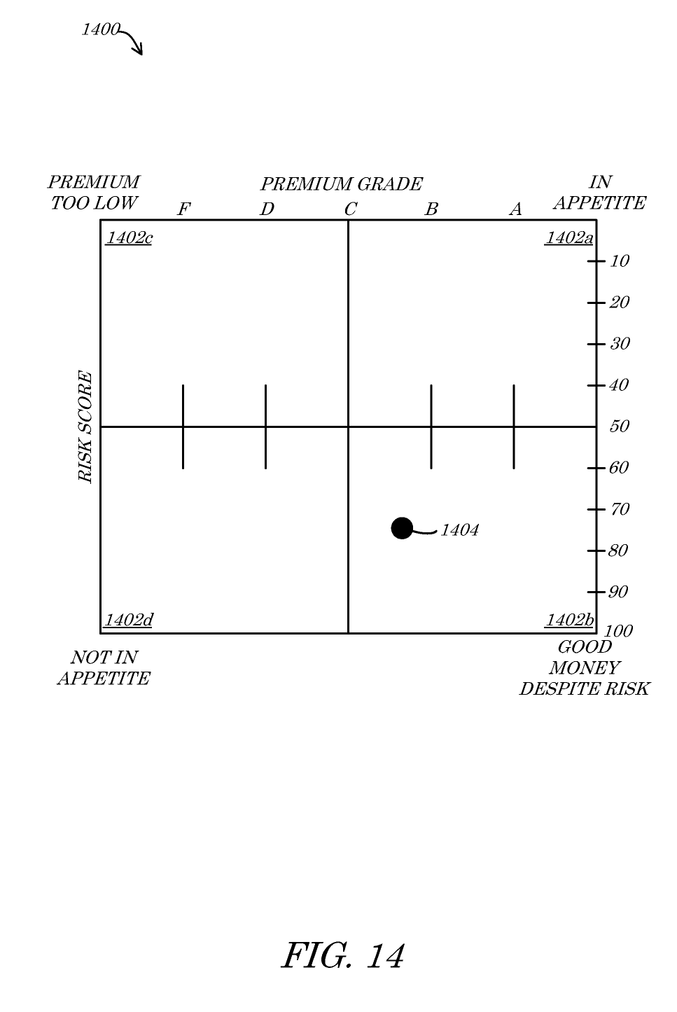

Referring to FIG. 14, for example, a diagram of an exemplary risk matrix 1400 according to some embodiments is shown. In some embodiments (as depicted), the risk matrix 1400 may comprise a simple two-dimensional graph having an X-axis and a Y-axis. Any other type of risk matrix, or no risk matrix, may be used if desired. The detail, complexity, and/or dimensionality of the risk matrix 1400 may vary as desired and/or may be tied to a particular insurance product or offering. In some embodiments, the risk matrix 1400 may be utilized to visually illustrate a relationship between the risk score (e.g., from 904 of FIG. 9, 1130 of FIG. 11, and/or from 1210 of FIG. 12) of an object and/or activity (and/or account and/or group or list of objects/activities) and the total determined premium (e.g., from 906 of FIG. 9, 1140 of FIG. 11, and/or 1308 of FIG. 13; and/or a grading thereof, such as from 1310 of FIG. 13) for an insurance product offered in relation to the object and/or activity (and/or account and/or group or list of objects/activities). As shown in FIG. 14, for example, the premium grade may be plotted along the X-axis of the risk matrix 1400 and/or the risk score may be plotted along the Y-axis of the risk matrix 1400.

In such a manner, the risk matrix 1400 may comprise four (4) quadrants 1402a-d (e.g., similar to a “four-square” evaluation sheet utilized by automobile dealers to evaluate the propriety of various possible pricing “deals” for new automobiles). The first quadrant 1402a represents the most desirable situations where risk scores are low and premiums are highly graded. The second quadrant 1402b represents less desirable situations where, while premiums are highly graded, risk scores are higher. Generally, object-specific data that results in data points being plotted in either of the first two quadrants 1402a-b is indicative of an object for which an insurance product may be offered on terms likely to be favorable to the insurer. The third quadrant 1402c represents less desirable characteristics of having poorly graded premiums with low risk scores and the fourth quadrant 1402d represents the least desirable characteristics of having poorly graded premiums as well as high risk scores. Generally, object-specific data that results in data points being plotted in either of the third and fourth quadrants 1402c-d is indicative of an object for which an insurance product offering is not likely to be favorable to the insurer.

One example of how the risk matrix 1400 may be output and/or implemented with respect to autonomous vehicle variables of an account and/or group of objects will now be described. Assume, for example, that an automobile insurance policy is desired by a consumer with respect to an autonomous vehicle and/or that such an insurance policy product is otherwise analyzed to determine whether such a policy would be beneficial for an insurer to issue. Typical risk metrics such as the operator's age, gender, driving history, miles driven per year, and/or color of the vehicle may be utilized to produce expected loss frequency and loss severity distributions (such as determined at 1206b and 1208b of FIG. 12).

In some embodiments, autonomous vehicle metrics associated with the customer, account, and/or one or more specific autonomous vehicles that the customer desires to insure (i.e., the objects/activities being insured), such as an expected benefit or detriment to risk/loss due to the autonomous vehicle's ability to drive itself (e.g., at or near the driverless end of the automation spectrum), may also be utilized to produce expected autonomous vehicle loss frequency and autonomous vehicle loss severity distributions (such as determined at 1206a and 1208a of FIG. 12). According to some embodiments, singular loss frequency and loss severity distributions may be determined utilizing both typical risk metrics, as well as autonomous vehicle metrics (of the activity being insured and/or of other associated objects/activities, such as other vehicles, businesses, and/or activities belonging to and/or associated with the same account, sub-account, etc.).

In the case that the autonomous vehicle risk score for the account is greater than a certain pre-determined magnitude (e.g., threshold), based on a calculated modified risk score for example, the risk score for the activity and/or account may be determined to be relatively high, such as seventy-five (75) on a scale from zero (0) to one hundred (100), as compared to a score of fifty (50) for a second autonomous vehicle risk score (e.g., based on different autonomous vehicle such as a different autonomous vehicle logic, circuitry, and/or device type). Other non-autonomous vehicle factors such as the loss history for the account/object(s)/activity (and/or other factors) may also contribute to the risk score for the consumer, account, activity, vehicle(s), and/or insurance product associated therewith.

The total premium calculated for a potential insurance policy offering covering the vehicle/account/object(s)/activity (e.g., determined at 1308 of FIG. 13) may, to continue the example, be graded between “B” and “C” (e.g., at 1310 of FIG. 13) or between “Fair” and “Average”. The resulting combination of risk score and premium rating may be plotted on the risk matrix 1400, as represented by a data point 1404 shown in FIG. 14. The data point 1404, based on the autonomous vehicle-influenced risk score and the corresponding autonomous vehicle-influenced premium calculation, is plotted in the second quadrant 1402b, in a position indicating that while the risk of insuring the vehicle/account/object(s)/activity is relatively high, the calculated premium is probably large enough to compensate for the level of risk. In some embodiments, an insurer may accordingly look favorably upon issuing such as insurance policy to the client to cover the vehicle(s), account, object(s), and/or activity in question and/or may consummate a sale of such a policy to the consumer (e.g., based on the evaluation output at 1312 of FIG. 13, such as decision and/or sale may be made).

Referring to FIG. 15, a block diagram of an apparatus 1510 according to some embodiments is shown. In some embodiments, the apparatus 1510 may be similar in configuration and/or functionality to any of the controller device 1010, the user devices 1002a-n, and/or the third-party device 1006, all of FIG. 10 herein. The apparatus 1510 may, for example, execute, process, facilitate, and/or otherwise be associated with the methods 900, 1100, 1200, 1300 of FIG. 9, FIG. 11, FIG. 12, and/or FIG. 13 and/or portions or combinations thereof described herein. In some embodiments, the apparatus 1510 may comprise a processing device 1512, an input device 1514, an output device 1516, a communication device 1518, a memory device 1540, and/or a cooling device 1550. According to some embodiments, any or all of the components 1512, 1514, 1516, 1518, 1540, 1550 of the apparatus 1510 may be similar in configuration and/or functionality to any similarly named and/or numbered components described herein. Fewer or more components 1512, 1514, 1516, 1518, 1540, 1550 and/or various configurations of the components 1512, 1514, 1516, 1518, 1540, 1550 may be included in the apparatus 1510 without deviating from the scope of embodiments described herein.

According to some embodiments, the processor 1512 may be or include any type, quantity, and/or configuration of processor that is or becomes known. The processor 1512 may comprise, for example, an Intel® IXP 2800 network processor or an Intel® XEON™ Processor coupled with an Intel® E7501 chipset. In some embodiments, the processor 1512 may comprise multiple inter-connected processors, microprocessors, and/or micro-engines. According to some embodiments, the processor 1512 (and/or the apparatus 1510 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 1510 comprises a server such as a blade server, necessary power may be supplied via a standard AC outlet, power strip, surge protector, and/or Uninterruptible Power Supply (UPS) device.

In some embodiments, the input device 1514 and/or the output device 1516 are communicatively coupled to the processor 1512 (e.g., via wired and/or wireless connections and/or pathways) and they may generally comprise any types or configurations of input and output components and/or devices that are or become known, respectively. The input device 1514 may comprise, for example, a keyboard that allows an operator of the apparatus 1510 to interface with the apparatus 1510 (e.g., by a consumer, such as to purchase insurance policies priced utilizing autonomous vehicle metrics, and/or by an underwriter and/or insurance agent, such as to evaluate risk and/or calculate premiums for an insurance policy, e.g., based on autonomous vehicle variables as described herein). In some embodiments, the input device 1514 may comprise a sensor configured to provide information such as encoded location, autonomous vehicle variable and/or risk, and/or autonomous vehicle data to the apparatus 1510 and/or the processor 1512. The output device 1516 may, according to some embodiments, comprise a display screen and/or other practicable output component and/or device. The output device 1516 may, for example, provide insurance and/or investment pricing, claims, and/or risk analysis to a potential client (e.g., via a website) and/or to an underwriter, claim handler, or sales agent attempting to structure an insurance (and/or investment) product and/or investigate an insurance claim (e.g., via a computer workstation). According to some embodiments, the input device 1514 and/or the output device 1516 may comprise and/or be embodied in a single device such as a touch-screen monitor.

In some embodiments, the communication device 1518 may comprise any type or configuration of communication device that is or becomes known or practicable. The communication device 1518 may, for example, comprise a Network Interface Card (NIC), a telephonic device, a cellular network device, a router, a hub, a modem, and/or a communications port or cable. In some embodiments, the communication device 1518 may be coupled to provide data to a client device, such as in the case that the apparatus 1510 is utilized to price and/or sell underwriting products (e.g., based at least in part on autonomous vehicle data). The communication device 1518 may, for example, comprise a cellular telephone network transmission device that sends signals indicative of autonomous vehicle metrics to a handheld, mobile, and/or telephone device (e.g., of a claim adjuster). According to some embodiments, the communication device 1518 may also or alternatively be coupled to the processor 1512. In some embodiments, the communication device 1518 may comprise an IR, RF, Bluetooth™, Near-Field Communication (NFC), and/or Wi-Fi® network device coupled to facilitate communications between the processor 1512 and another device (such as a client device and/or a third-party device, not shown in FIG. 15).

The memory device 1540 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 1540 may, according to some embodiments, store one or more of autonomous vehicle data instructions 1542-1, risk assessment instructions 1542-2, underwriting instructions 1542-3, premium determination instructions 1542-4, client data 1544-1, autonomous vehicle data 1544-2, underwriting data 1544-3, and/or claim/loss data 1544-4. In some embodiments, the autonomous vehicle data instructions 1542-1, risk assessment instructions 1542-2, underwriting instructions 1542-3, premium determination instructions 1542-4 may be utilized by the processor 1512 to provide output information via the output device 1516 and/or the communication device 1518.

According to some embodiments, the autonomous vehicle data instructions 1542-1 may be operable to cause the processor 1512 to process the client data 1544-1, autonomous vehicle data 1544-2, underwriting data 1544-3, and/or claim/loss data 1544-4 in accordance with embodiments as described herein. Client data 1544-1, autonomous vehicle data 1544-2, underwriting data 1544-3, and/or claim/loss data 1544-4 received via the input device 1514 and/or the communication device 1518 may, for example, be analyzed, sorted, filtered, decoded, decompressed, ranked, scored, plotted, and/or otherwise processed by the processor 1512 in accordance with the autonomous vehicle data instructions 1542-1. In some embodiments, client data 1544-1, autonomous vehicle data 1544-2, underwriting data 1544-3, and/or claim/loss data 1544-4 may be fed by the processor 1512 through one or more mathematical and/or statistical formulas and/or models in accordance with the autonomous vehicle data instructions 1542-1 to define one or more autonomous vehicle risk and/or autonomous vehicle metrics, indices, and/or models that may then be utilized to inform and/or affect insurance and/or other underwriting product determinations and/or sales as described herein.

In some embodiments, the risk assessment instructions 1542-2 may be operable to cause the processor 1512 to process the client data 1544-1, autonomous vehicle data 1544-2, underwriting data 1544-3, and/or claim/loss data 1544-4 in accordance with embodiments as described herein. Client data 1544-1, autonomous vehicle data 1544-2, underwriting data 1544-3 (e.g., environmental data and/or third-party data utilized to assess risk, price, quote, sell, and/or otherwise provide one or more services), and/or claim/loss data 1544-4 received via the input device 1514 and/or the communication device 1518 may, for example, be analyzed, sorted, filtered, decoded, decompressed, ranked, scored, plotted, and/or otherwise processed by the processor 1512 in accordance with the risk assessment instructions 1542-2. In some embodiments, client data 1544-1, autonomous vehicle data 1544-2, underwriting data 1544-3, and/or claim/loss data 1544-4 may be fed by the processor 1512 through one or more mathematical and/or statistical formulas and/or models in accordance with the risk assessment instructions 1542-2 to inform and/or affect risk assessment processes and/or decisions in relation to autonomous vehicle parameters and/or autonomous vehicle data feature and/or variables, as described herein.

According to some embodiments, the underwriting instructions 1542-3 may be operable to cause the processor 1512 to process the client data 1544-1, autonomous vehicle data 1544-2, underwriting data 1544-3, and/or claim/loss data 1544-4 in accordance with embodiments as described herein. Client data 1544-1, autonomous vehicle data 1544-2, underwriting data 1544-3, and/or claim/loss data 1544-4 received via the input device 1514 and/or the communication device 1518 may, for example, be analyzed, sorted, filtered, decoded, decompressed, ranked, scored, plotted, and/or otherwise processed by the processor 1512 in accordance with the underwriting instructions 1542-3. In some embodiments, client data 1544-1, autonomous vehicle data 1544-2, underwriting data 1544-3, and/or claim/loss data 1544-4 may be fed by the processor 1512 through one or more mathematical and/or statistical formulas and/or models in accordance with the underwriting instructions 1542-3 to cause, facilitate, inform, and/or affect underwriting product determinations and/or sales (e.g., based at least in part on autonomous vehicle data) as described herein.

In some embodiments, the premium determination instructions 1542-4 may be operable to cause the processor 1512 to process the client data 1544-1, autonomous vehicle data 1544-2, underwriting data 1544-3, and/or claim/loss data 1544-4 in accordance with embodiments as described herein. Client data 1544-1, autonomous vehicle data 1544-2, underwriting data 1544-3, and/or claim/loss data 1544-4 received via the input device 1514 and/or the communication device 1518 may, for example, be analyzed, sorted, filtered, decoded, decompressed, ranked, scored, plotted, and/or otherwise processed by the processor 1512 in accordance with the premium determination instructions 1542-4. In some embodiments, client data 1544-1, autonomous vehicle data 1544-2, underwriting data 1544-3, and/or claim/loss data 1544-4 may be fed by the processor 1512 through one or more mathematical and/or statistical formulas and/or models in accordance with the premium determination instructions 1542-4 to cause, facilitate, inform, and/or affect underwriting product premium determinations and/or sales (e.g., based at least in part on autonomous vehicle data) as described herein.

In some embodiments, the apparatus 1510 may function as a computer terminal and/or server of an insurance and/or underwriting company, for example, that is utilized to process insurance claims and/or applications. In some embodiments, the apparatus 1510 may comprise a web server and/or other portal (e.g., an Interactive Voice Response Unit (IVRU)) that provides VED-based claim and/or underwriting product determinations and/or products to clients.

In some embodiments, the apparatus 1510 may comprise the cooling device 1550. According to some embodiments, the cooling device 1550 may be coupled (physically, thermally, and/or electrically) to the processor 1512 and/or to the memory device 1540. The cooling device 1550 may, for example, comprise a fan, heat sink, heat pipe, radiator, cold plate, and/or other cooling component or device or combinations thereof, configured to remove heat from portions or components of the apparatus 1510.

Any or all of the exemplary instructions and data types described herein and other practicable types of data may be stored in any number, type, and/or configuration of memory devices that is or becomes known. The memory device 1540 may, for example, comprise one or more data tables or files, databases, table spaces, registers, and/or other storage structures. In some embodiments, multiple databases and/or storage structures (and/or multiple memory devices 1540) may be utilized to store information associated with the apparatus 1510. According to some embodiments, the memory device 1540 may be incorporated into and/or otherwise coupled to the apparatus 1510 (e.g., as shown) or may simply be accessible to the apparatus 1510 (e.g., externally located and/or situated).

Referring to FIG. 16A, FIG. 16B, FIG. 16C, FIG. 16D, and FIG. 16E, perspective diagrams of exemplary data storage devices 1640a-e according to some embodiments are shown. The data storage devices 1640a-d may, for example, be utilized to store instructions and/or data such as the autonomous vehicle data instructions 1542-1, risk assessment instructions 1542-2, underwriting instructions 1542-3, premium determination instructions 1542-4, client data 1544-1, autonomous vehicle data 1544-2, underwriting data 1544-3, and/or claim/loss data 1544-4, each of which is described in reference to FIG. 15 herein. In some embodiments, instructions stored on the data storage devices 1640a-d may, when executed by a processor, cause the implementation of and/or facilitate the methods 900, 1100, 1200, 1300 of FIG. 9, FIG. 11, FIG. 12, and/or FIG. 13 and/or portions or combinations thereof described herein.

According to some embodiments, the first data storage device 1640a may comprise one or more various types of internal and/or external hard drives. The first data storage device 1640a may, for example, comprise a data storage medium 1646 that is read, interrogated, and/or otherwise communicatively coupled to and/or via a disk reading device 1648. In some embodiments, the first data storage device 1640a and/or the data storage medium 1646 may be configured to store information utilizing one or more magnetic, inductive, and/or optical means (e.g., magnetic, inductive, and/or optical-encoding). The data storage medium 1646, depicted as a first data storage medium 1646a for example (e.g., breakout cross-section “A”), may comprise one or more of a polymer layer 1646a-1, a magnetic data storage layer 1646a-2, a non-magnetic layer 1646a-3, a magnetic base layer 1646a-4, a contact layer 1646a-5, and/or a substrate layer 1646a-6. According to some embodiments, a magnetic read head 1648a may be coupled and/or disposed to read data from the magnetic data storage layer 1646a-2.

In some embodiments, the data storage medium 1646, depicted as a second data storage medium 1646b for example (e.g., breakout cross-section “B”), may comprise a plurality of data points 1646b-2 disposed with the second data storage medium 1646b. The data points 1646b-2 may, in some embodiments, be read and/or otherwise interfaced with via a laser-enabled read head 1648b disposed and/or coupled to direct a laser beam through the second data storage medium 1646b.

In some embodiments, the second data storage device 1640b may comprise a CD, CD-ROM, DVD, Blu-Ray™ Disc, and/or other type of optically-encoded disk and/or other storage medium that is or becomes know or practicable. In some embodiments, the third data storage device 1640c may comprise a USB keyfob, dongle, and/or other type of flash memory data storage device that is or becomes know or practicable. In some embodiments, the fourth data storage device 1640d may comprise RAM of any type, quantity, and/or configuration that is or becomes practicable and/or desirable. In some embodiments, the fourth data storage device 1640d may comprise an off-chip cache such as a Level 2 (L2) cache memory device. According to some embodiments, the fifth data storage device 1640e may comprise an on-chip memory device such as a Level 1 (L1) cache memory device.

The data storage devices 1640a-e may generally store program instructions, code, and/or modules that, when executed by a processing device cause a particular machine to function in accordance with one or more embodiments described herein. The data storage devices 1640a-e depicted in FIG. 16A, FIG. 16B, FIG. 16C, FIG. 16D, and FIG. 16E are representative of a class and/or subset of computer-readable media that are defined herein as “computer-readable memory” (e.g., non-transitory memory devices as opposed to transmission devices or media).

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

According to some embodiments, systems, articles of manufacture (e.g., non-transitory computer-readable memory), methods may comprise determining (e.g., by a processing device) a plurality of autonomous vehicle parameters descriptive of a vehicle for which an insurance policy is sought, determining (e.g., by the processing device), for each autonomous vehicle parameter of the plurality of autonomous vehicle parameters, an autonomous vehicle scoring factor, determining (e.g., by the processing device) a summation of the autonomous vehicle scoring factors for the plurality of autonomous vehicle parameters, determining (e.g., by the processing device), based on the summation of the autonomous vehicle scoring factors for the plurality of autonomous vehicle parameters, an autonomous vehicle modifier metric, determining (e.g., by the processing device) at least one of (i) a risk assessment parameter for the vehicle and (ii) an insurance premium parameter for the vehicle, determining (e.g., by the processing device), based on an application of the autonomous vehicle modifier metric to the at least one of (i) the risk assessment parameter for the vehicle and (ii) the insurance premium factor for the vehicle, at least one of (i) an autonomous vehicle risk assessment parameter for the vehicle and (ii) an autonomous vehicle insurance premium parameter for the vehicle, and/or causing (e.g., by the processing device) an outputting of the at least one of (i) the autonomous vehicle risk assessment parameter for the vehicle and (ii) the autonomous vehicle insurance premium parameter for the vehicle. In some embodiments, methods may comprise selling, to a consumer, the insurance policy based on the output at least one of (i) the autonomous vehicle risk assessment parameter for the vehicle and (ii) the autonomous vehicle insurance premium parameter for the vehicle. In some embodiments, the autonomous vehicle scoring factor for each autonomous vehicle parameter of the plurality of autonomous vehicle parameters may be based on autonomous vehicle risk data associated with each respective autonomous vehicle parameter of the plurality of autonomous vehicle parameters. In some embodiments, the autonomous vehicle risk data may comprise data descriptive of at least one of a frequency and a magnitude of loss attributable to a particular autonomous vehicle feature of the vehicle. In some embodiments, at least one autonomous vehicle parameter of the plurality of autonomous vehicle parameters may comprise a parameter descriptive of at least one of: (i) an available incentive for the vehicle; (ii) marketplace data regarding autonomous vehicle usage; (iii) roadway data regarding autonomous vehicle usage; and (iv) warranty data for the vehicle. In some embodiments, at least one autonomous vehicle parameter of the plurality of autonomous vehicle parameters may comprise a parameter descriptive of at least one of: (i) an ability of a home automation system to communicate with the vehicle and (ii) available remote driving options for the vehicle. In some embodiments, at least one autonomous vehicle parameter of the plurality of autonomous vehicle parameters may comprise a parameter descriptive of at least one of: (i) an autonomous vehicle experience level of an operator of the vehicle; (ii) a propensity of the operator to utilize technology; (iii) physical attributes of the operator; and (iv) an occupation of the operator. In some embodiments, at least one autonomous vehicle parameter of the plurality of autonomous vehicle parameters may comprise a parameter descriptive of at least one of: (i) a cost of an autonomous vehicle feature of the vehicle and (ii) a maintenance requirement for an autonomous vehicle feature of the vehicle.

1. A system, comprising:
a processing device; and
a memory device in communication with the processing device, the memory device storing instructions that when executed by the processing device result in:
determining a level of automation of a vehicle, wherein the determining of the level of automation of the vehicle comprises (i) receiving, from a diagnostic device of a vehicle, data descriptive of a plurality of autonomous vehicle variables of the vehicle, and (ii) calculating a score for each autonomous vehicle variable of the plurality of autonomous vehicle variables;
determining, based on the level of automation of the vehicle, a risk assessment for the vehicle;
determining, based on the risk assessment for the vehicle, an insurance parameter for the vehicle; and
causing an outputting of an indication of the insurance parameter for the vehicle.

2. The system of claim 1, wherein the instructions, when executed by the processing device, further result in:
selling, to a consumer, an insurance policy based at least in part on the output insurance parameter.

3. (canceled)

4. The system of claim 1, wherein the determining of the level of automation of the vehicle further comprises:
determining, based on the scores of the plurality of autonomous vehicle variables, at least one of (i) a risk modifier and (ii) an insurance parameter modifier.

5. The system of claim 4, wherein the determining of the risk modifier comprises:
determining, for each autonomous vehicle variable of the plurality of autonomous vehicle variables, a risk reduction factor;
determining, for each autonomous vehicle variable of the plurality of autonomous vehicle variables, a cost factor;
determining, for each autonomous vehicle variable of the plurality of autonomous vehicle variables, a manual override factor; and
combining, for each autonomous vehicle variable of the plurality of autonomous vehicle variables, the (i) score, (ii) the risk reduction factor, (iii) the cost factor, and (iv) the manual override factor.

6. The system of claim 5, wherein the combining comprises:
multiplying, for each autonomous vehicle variable of the plurality of autonomous vehicle variables, the (i) score, (ii) the risk reduction factor, (iii) the cost factor, and (iv) the manual override factor; and
summing the products of the multiplying.

7. The system of claim 6, wherein the determining of the risk modifier further comprises:
determining, based on the sum of the products of the multiplying, a corresponding multiplier indicated by a data record stored in a database.

8. The system of claim 4, wherein the determining of the risk assessment for the vehicle comprises:
determining an initial risk assessment for the vehicle; and
defining a modified risk assessment for the vehicle by applying the risk modifier to the initial risk assessment.

9. The system of claim 4, wherein the determining of the insurance parameter modifier comprises:
determining, for each autonomous vehicle variable of the plurality of autonomous vehicle variables, a liability reduction factor and a physical damage reduction factor;
determining, for each autonomous vehicle variable of the plurality of autonomous vehicle variables, a cost factor;
determining, for each autonomous vehicle variable of the plurality of autonomous vehicle variables, a manual override factor;
combining, for each autonomous vehicle variable of the plurality of autonomous vehicle variables, the (i) score, (ii) the liability reduction factor, (iii) the cost factor, and (iv) the manual override factor, thereby defining a liability score for each variable; and
combining, for each autonomous vehicle variable of the plurality of autonomous vehicle variables, the (i) score, (ii) the physical damage reduction factor, (iii) the cost factor, and (iv) the manual override factor, thereby defining a physical damage score for each variable.

10. The system of claim 9, wherein the combining of the (i) score, (ii) the liability reduction factor, (iii) the cost factor, and (iv) the manual override factor, comprises:
multiplying, for each autonomous vehicle variable of the plurality of autonomous vehicle variables, the (i) score, (ii) the liability reduction factor, (iii) the cost factor, and (iv) the manual override factor, thereby defining a liability score for each variable; and
summing the liability scores; and
wherein the combining of the (i) score, (ii) the physical damage reduction factor, (iii) the cost factor, and (iv) the manual override factor, comprises:
multiplying, for each autonomous vehicle variable of the plurality of autonomous vehicle variables, the (i) score, (ii) the physical damage reduction factor, (iii) the cost factor, and (iv) the manual override factor, thereby defining a physical damage score for each variable; and
summing the physical damage scores.

11. The system of claim 10, wherein the determining of the insurance parameter further comprises:
determining, based on the sums of the liability scores and the physical damage scores, a corresponding multiplier indicated by a data record stored in a database.

12. The system of claim 4, wherein the determining of the insurance parameter for the vehicle comprises:
determining an initial insurance parameter for the vehicle; and
defining a modified insurance parameter for the vehicle by applying the insurance parameter modifier to the initial insurance parameter.

13. The system of claim 1, wherein the vehicle comprises a plurality of vehicles.

14. The system of claim 13, wherein the plurality of vehicles comprises a commercial fleet of vehicles.

15. The system of claim 13, wherein the plurality of vehicles comprises multiple vehicles of a single household.

16. A non-transitory computer-readable memory storing instructions that when executed by a processing device result in:
determining a level of automation of a vehicle, wherein the determining of the level of automation of the vehicle comprises (i) receiving, from a diagnostic device of a vehicle, data descriptive of a plurality of autonomous vehicle variables of the vehicle, and
(ii) calculating a score for each autonomous vehicle variable of the plurality of autonomous vehicle variables;
determining, based on the level of automation of the vehicle, a risk assessment for the vehicle;
determining, based on the risk assessment for the vehicle, an insurance parameter for the vehicle; and
causing an outputting of an indication of the insurance parameter for the vehicle.

17. The non-transitory computer-readable memory of claim 16, wherein the instructions, when executed by the processing device, further result in:
selling, to a consumer, an insurance policy based at least in part on the output insurance parameter.

18. (canceled)

19. The non-transitory computer-readable memory of claim 16, wherein the determining of the level of automation of the vehicle further comprises:
determining, based on the scores of the plurality of autonomous vehicle variables, at least one of (i) a risk modifier and (ii) an insurance parameter modifier.

20. The non-transitory computer-readable memory of claim 19, wherein the determining of the risk modifier comprises:
determining, for each autonomous vehicle variable of the plurality of autonomous vehicle variables, a risk reduction factor;
determining, for each autonomous vehicle variable of the plurality of autonomous vehicle variables, a cost factor;
determining, for each autonomous vehicle variable of the plurality of autonomous vehicle variables, a manual override factor; and
combining, for each autonomous vehicle variable of the plurality of autonomous vehicle variables, the (i) score, (ii) the risk reduction factor, (iii) the cost factor, and (iv) the manual override factor.

21. The non-transitory computer-readable memory of claim 19, wherein the determining of the risk assessment for the vehicle comprises:
determining an initial risk assessment for the vehicle; and
defining a modified risk assessment for the vehicle by applying the risk modifier to the initial risk assessment.

22. The non-transitory computer-readable memory of claim 19, wherein the determining of the insurance parameter modifier comprises:
determining, for each autonomous vehicle variable of the plurality of autonomous vehicle variables, a liability reduction factor and a physical damage reduction factor;
determining, for each autonomous vehicle variable of the plurality of autonomous vehicle variables, a cost factor;
determining, for each autonomous vehicle variable of the plurality of autonomous vehicle variables, a manual override factor;
combining, for each autonomous vehicle variable of the plurality of autonomous vehicle variables, the (i) score, (ii) the liability reduction factor, (iii) the cost factor, and (iv) the manual override factor, thereby defining a liability score for each variable; and
combining, for each autonomous vehicle variable of the plurality of autonomous vehicle variables, the (i) score, (ii) the physical damage reduction factor, (iii) the cost factor, and (iv) the manual override factor, thereby defining a physical damage score for each variable.

23. The non-transitory computer-readable memory of claim 19, wherein the determining of the insurance parameter for the vehicle comprises:
determining an initial insurance parameter for the vehicle; and
defining a modified insurance parameter for the vehicle by applying the insurance parameter modifier to the initial insurance parameter.
